(19) United States
(12) Patent Application Publication
(10) Pub. No.: US 2026/0094426 A1
(43) Pub. Date: Apr. 2, 2026

(54) INFORMATION PROCESSING METHOD, INFORMATION PROCESSING DEVICE, AND PROGRAM

(71) Applicant: Sony Group Corporation, Tokyo (JP)

(72) Inventor: Manabu KAWASHIMA, Tokyo (JP)

(73) Assignee: Sony Group Corporation, Tokyo (JP)

(21) Appl. No.: 19/114,801

(22) PCT Filed: Oct. 25, 2023
(86) PCT No.: PCT/JP2023/038556

§ 371 Date: Mar. 25, 2025

(30) Foreign Application Priority Data
Nov. 29, 2022 (JP) 2022-189993

(51) Int. Cl. G06V 10/82; G06V 10/25; G06V 10/26

(52) U.S. Cl. CPC G06V 10/82; G06V 10/25; G06V 10/26

(57) ABSTRACT

An information processing apparatus including circuitry configured to receive a first image, receive a model from a learning device, and output a first position and a first posture based on a first image feature amount extracted from the first image and the model, wherein the model is obtained by determining at least one overlap point between a second image and a third image, dividing the second image into an overlap region including the at least one overlap point and a non-overlap region in response to determining the at least one overlap point, and performing training based on a second image feature amount corresponding to the overlap region and a third image feature amount corresponding to the non-overlap region.

### CROSS REFERENCE TO RELATED APPLICATIONS

This application claims the benefit of Japanese Priority Patent Application JP 2022-189993 filed on Nov. 29, 2022, the entire contents of which are in-corporated herein by reference.

### TECHNICAL FIELD

The present disclosure relates to an information processing method, an information processing device, and a program.

### BACKGROUND ART

Techniques for extracting a feature amount from an image are being used these days. For example, a technique for extracting a feature amount from an image is used for an image retrieval technique. In the image retrieval technique, a DB image similar to a query image is retrieved from a plurality of DB images registered beforehand in a database (DB). At this point of time, whether or not the query image and the DB image are similar to each other is determined depending on whether or not the image feature amount extracted from the query image and the image feature amount extracted from the DB image are close to each other.

NPL 1 discloses an example of an image retrieval technique. By the image retrieval technique disclosed in NPL 1, a DB image is divided into a plurality of regions each having a fixed size, and a check is made to determine whether or not each region of the plurality of regions overlaps with a query image depending on whether or not an image feature amount extracted from each region of the plurality of regions is close to an image feature amount extracted from the query image. A region of the DB image determined to overlap with the query image (this region will be hereinafter also referred to as an “overlap region”) is then preferentially used to contribute to learning.

Note that an overlap region in the DB image is a region similar to part or all of the region of the query image.

A model obtained by learning is used to extract an image feature amount. For example, a model obtained by learning can be implemented with a deep neural network (DNN) or the like. Accordingly, extracting an image feature amount from an image with higher accuracy by a model obtained by learning can contribute to improving the accuracy of image retrieval as an example.

### CITATION LIST

### Non Patent Literature

NPL 1: Yixiao Ge, et al. “Self-supervising Fine-grained Region Similarities for Large-scale Image Localization”, ECCV 2020

### SUMMARY

### Technical Problem

In view of the above, there is a demand for a technology for enabling extraction of an image feature amount from an image with higher accuracy, using a model obtained by learning.

### Solution to Problem

According to the present disclosure, an information processing device is provided that includes circuitry configured to receive a first image, receive a model from a learning device, and output a first position and a first posture based on a first image feature amount extracted from the first image and the model, wherein the model is obtained by determining at least one overlap point between a second image and a third image, dividing the second image into an overlap region including the at least one overlap point and a non-overlap region in response to determining the at least one overlap point, and performing training based on a second image feature amount corresponding to the overlap region and a third image feature amount corresponding to the non-overlap region.

Furthermore, according to the present disclosure, an information processing method includes receiving a first image, receiving a model from a learning device, and outputting a first position and a first posture based on a first image feature amount extracted from the first image and the model, wherein the model is obtained by determining at least one overlap point between a second image and a third image, dividing the second image into an overlap region including the at least one overlap point and a non-overlap region in response to determining the at least one overlap point, and performing training based on a second image feature amount corresponding to the overlap region and a third image feature amount corresponding to the non-overlap region.

In addition, according to the present disclosure, a non-transitory computer-readable medium is provided having embodied thereon a program, which when executed by a computer causes the computer to function as execute an information processing method, the method including receiving a first image, receiving a model from a learning device, and outputting a first position and a first posture based on a first image feature amount extracted from the first image and the model, wherein the model is obtained by determining at least one overlap point between a second image and a third image, dividing the second image into an overlap region including the at least one overlap point and a non-overlap region in response to determining the at least one overlap point, and performing training based on a second image feature amount corresponding to the overlap region and a third image feature amount corresponding to the non-overlap region.

### BRIEF DESCRIPTION OF DRAWINGS

FIG. 1 is a diagram illustrating an example configuration of an information processing system according to an embodiment of the present disclosure.

FIG. 2 is a diagram for explaining an example of image retrieval.

FIG. 3 is a diagram illustrating an example operation of estimating device position/posture information about an imaging device 110 at the time of capture of an inference query image G3.

FIG. 4 is a diagram for explaining a method for learning an image feature amount extracting DNN according to a comparative example.

FIG. 5 is a diagram for explaining the problems of the comparative example.

FIG. 6 is a diagram illustrating the flow of a method for learning an image feature amount extracting DNN according to the embodiment of the present disclosure.

FIG. 7 is a diagram for explaining the method for learning the image feature amount extracting DNN according to the embodiment of the present disclosure.

FIG. 8 is a diagram illustrating an example functional configuration of a terminal device 10 according to the embodiment of the present disclosure.

FIG. 9 is a diagram illustrating an example functional configuration of an inference device 30 according to the embodiment of the present disclosure.

FIG. 10 is a diagram illustrating a specific example configuration of an image retrieval unit 310.

FIG. 11 is a diagram illustrating a specific example configuration of a feature point matching unit 320.

FIG. 12 is a diagram illustrating an example functional configuration of a learning device 20 according to the embodiment of the present disclosure.

FIG. 13 is a diagram illustrating a specific example configuration of a three-dimensional restoration unit 210 according to a first overlap point extraction method.

FIG. 14 is a diagram for explaining the respective functions of a position/posture estimation unit 212 and a depth estimation unit 214.

FIG. 15 is a diagram illustrating a specific example configuration of a three-dimensional restoration unit 210 according to a second overlap point extraction method.

FIG. 16 is a diagram of a three-dimensional point group as viewed obliquely from a side.

FIG. 17 is a diagram of a three-dimensional point group as viewed from above.

FIG. 18 is a diagram illustrating an example of a mesh.

FIG. 19 is a diagram for explaining a case where overlap points are extracted on the basis of mesh information.

FIG. 20 is a diagram illustrating a specific example configuration of a feature amount extraction unit 530 according to a comparative example.

FIG. 21 is a diagram illustrating a specific example configuration of a feature amount extraction unit 230 according to the embodiment of the present disclosure.

FIG. 22 is a diagram for explaining a first modification.

FIG. 23 is a diagram for explaining a second modification.

FIG. 24 is a diagram for explaining a third modification.

FIG. 25 is a diagram illustrating an example of an overlap region and a non-overlap region according to a third modification.

FIG. 26 is a block diagram illustrating an example hardware configuration of an information processing device 900.

### DESCRIPTION OF EMBODIMENTS

A preferred embodiment of the present disclosure is described below in detail, with reference to the accompanying drawings. Note that, in this specification and the drawings, components having substantially the same functional configurations are denoted by the same reference signs, and explanation thereof will not be repeated.

Furthermore, in the description and drawings, a plurality of components having substantially the same or similar functional configurations may be distinguished by different alphabets added to the same reference signs. However, in a case where there is no need to specifically distinguish a plurality of components having substantially the same or similar functional configurations from each other, only the same reference numerals are added thereto.

Note that the description will be made in the following order.
0. Outline
1. Details of an embodiment
1.1. Example functional configuration of a terminal device
1.2. Example functional configuration of an inference device
1.3. Example functional configuration of a learning device
2. Various modifications
3. Example hardware configuration
4. Conclusion

### 0. Outline

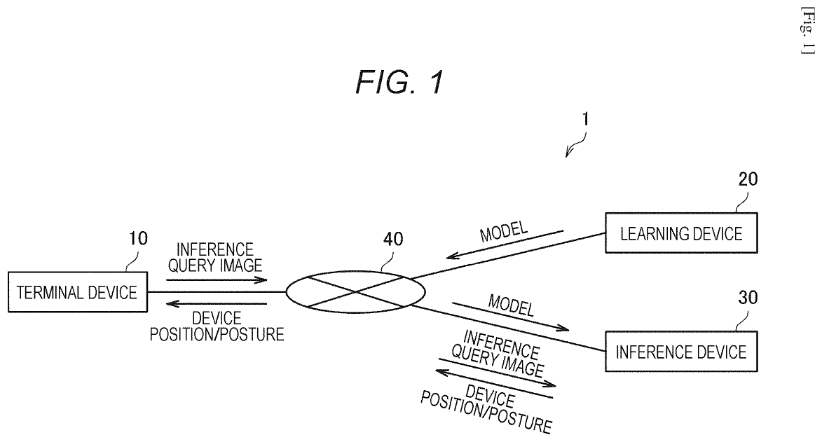

An outline of an embodiment of the present disclosure is first described, with reference to FIGS. 1 to 7.

FIG. 1 is a diagram illustrating an example configuration of an information processing system according to the embodiment of the present disclosure. As illustrated in FIG. 1, an information processing system 1 according to the embodiment of the present disclosure includes a terminal device 10, a learning device 20, and an inference device 30. The terminal device 10, the learning device 20, and the inference device 30 are each connected to a network 40, and are designed to be able to communicate with each other via the network 40.

First, the learning device 20 generates a model (which is an image feature amount extraction unit) that extracts an image feature amount from a query image to be used for inference (hereinafter also referred to as the “inference query image”), by training based on a query image to be used for learning (hereinafter also referred to as the “learning query image”) and one or a plurality of DB images to be used for learning (hereinafter also referred to as the “learning DB image(s)”). The inference query image may correspond to an example of a first image. In the embodiment of the present disclosure, a case where a model generated by the learning device 20 is implemented with a DNN is mainly assumed. However, a model may be generated by learning using some other machine learning algorithm. The learning device 20 transmits the model generated by learning to the inference device 30 via the network 40. The inference device 30 receives, via the network 40, the model transmitted from the learning device 20.

The inference device 30 includes a DB. In the DB, one or a plurality of DB images to be used for inference (hereinafter also referred to as the “inference DB image(s)”) are registered in advance. In the description below, the one or the plurality of inference DB images will be referred to as “all the inference DB images”in some cases.

In addition to the above, image feature amounts extracted from the inference DB images, and information indicating the positions and postures of the imaging device at the time of capture of the inference DB images are associated with the respective inference DB images and are registered in the DB. In the description below, a position and a posture will be also referred to as “position/posture”. Furthermore, in the description below, the position/posture information about the imaging device at the time of capture of an image will be also referred to simply as the “device position/posture information corresponding to the image”.

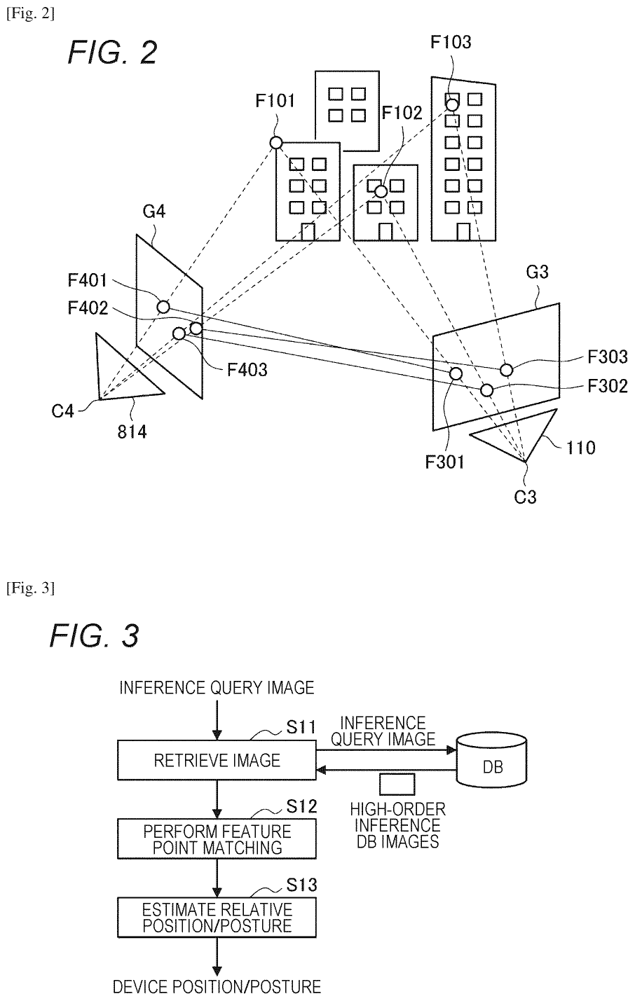

The terminal device 10 includes an imaging device. The terminal device 10 transmits the inference query image captured by the imaging device, to the inference device 30 via the network 40. The inference device 30 receives the inference query image via the network 40. The inference device 30 then estimates the degree of similarity between the inference query image and each inference DB image, and performs image retrieval for retrieving an inference DB image similar to the inference query image on the basis of the degree of similarity. An example of image retrieval is now briefly described with reference to FIG. 2.

FIG. 2 is a diagram for explaining an example of image retrieval. Referring to FIG. 2, feature points F101 to F103 exist in real space. Furthermore, each inference DB image, the image feature amount extracted from each inference DB image, and the device position/posture information corresponding to each inference DB image are registered in advance. The inference device 30 extracts an image feature amount from an inference query image G3, and calculates the difference between the image feature amount extracted from the inference query image G3 and the image feature amount extracted from each inference DB image.

Note that a difference between feature amounts may be a difference between vectors expressing image feature amounts. The inference device 30 ranks one or a plurality of inference DB images so that an inference DB image from which an image feature amount having a smaller difference from the image feature amount extracted from the inference query image G3 is extracted is ranked higher.

The inference query image G3 captured by an imaging device 110 in a position/posture C3 includes feature points F301 to F303 corresponding to the feature points F101 to F103. Further, an inference DB image G4 captured by an imaging device 814 in a position/posture C4 includes feature points F401 to F403 corresponding to the feature points F101 to F103. Note that the imaging device 110 and the imaging device 814 may be different imaging devices, or may be the same imaging device that performs imaging at different timings.

At this point of time, the feature points F301 to F303 appearing in the inference query image G3 and the feature points F401 to F403 appearing in the inference DB image G4 correspond to the same feature points F101 to F103 existing in the real space. Therefore, the difference between the image feature amount extracted from the inference query image G3 and the image feature amount extracted from the inference DB image G4 is small, and the inference DB image G4 is considered to be positioned at a higher rank in the order determined by the inference device 30.

From among the image feature amounts extracted from all the inference DB images, the inference device 30 then specifies a predetermined number of image feature amounts in ascending order of difference from the image feature amount extracted from the inference query image. In the description below, the inference DB images corresponding to the respective image feature amounts of the predetermined number of image feature amounts will be also referred to as “high-order inference DB images”.

Next, referring to FIG. 3, estimation of the device position/posture information about the imaging device 110 at the time of capture of the inference query image G3 is described.

FIG. 3 is a diagram illustrating an example operation of estimating the device position/posture information about the imaging device 110 at the time of capture of the inference query image G3. As illustrated in FIG. 3, image retrieval based on the inference query image is performed (S11). As described above, in the image retrieval, the high-order inference DB images corresponding to the inference query image are acquired from the DB by the inference device 30.

Subsequently, the inference device 30 performs matching of the feature points between the inference query image and the high-order inference DB images (S12). As a result, the corresponding pixels between the inference query image and the high-order inference DB images are obtained as corresponding point pairs.

Subsequently, the inference device 30 estimates a relative position/posture of the imaging device at the time of capture of the inference query image based on the device position/postures of the imaging device at the time of the high-order inference DB image, on the basis of the two-dimensional coordinates of the corresponding point pairs between the inference query image and the high-order inference DB images and the three-dimensional coordinates of the feature points of the corresponding point pairs in the high-order inference DB images (S13).

The inference device 30 estimates the device position/posture of the imaging device at the time of capture of the inference query image, on the basis of the device position/posture information corresponding to the high-order inference DB images and the relative position/posture of the imaging device at the time of capture the inference query image. For example, the series of operations of estimating the device position/posture information corresponds to a relocalization process by a simultaneous localization and mapping (SLAM) system.

The inference device 30 transmits the device position/posture information corresponding to the inference query image, to the terminal device 10 via the network 40. The terminal device 10 receives the device position/posture information via the network 40. Using the received device position/posture information, the terminal device 10 is capable of performing various kinds of processing.

The service that provides the device position/posture in this manner is also referred to as a visual positioning system (VPS), and can be provided as a cloud service to the terminal device 10 by the learning device 20 and the inference device 30.

Here, the terminal device 10 may be a smartphone or the like. At this point of time, in the terminal device 10, an augmented reality (AR) application for superimposing an AR object on the real space with high accuracy on the basis of the device position/posture information can be used. Alternatively, the terminal device 10 may be an autonomous mobile unit (such as a drone, for example) or the like. In this case, the autonomous mobile unit can move on the basis of the device position/posture information.

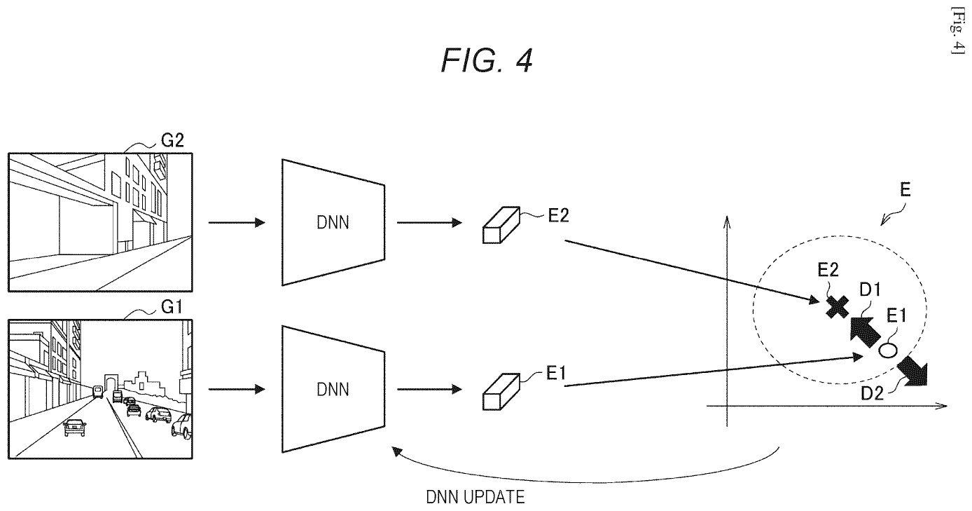

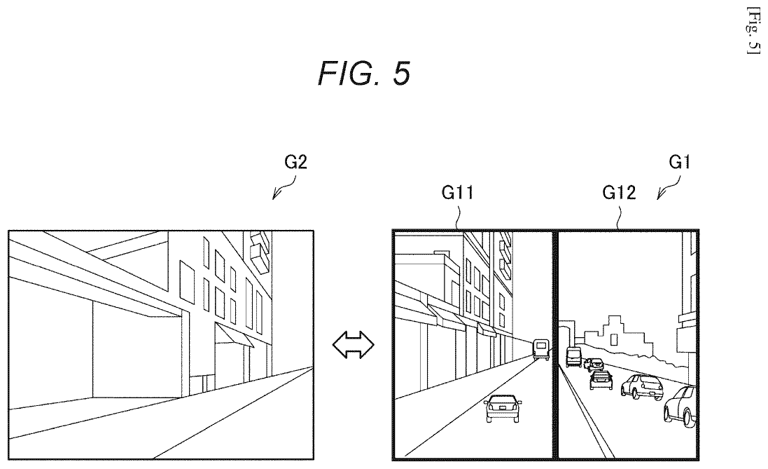

The model generated by the learning device 20 is implemented with a DNN, and the image feature amounts are extracted from the inference query image and each inference DB image by the model. Hereinafter, the DNN that extracts image feature amounts from images will be also referred to as the “image feature amount extracting DNN”. Contrastive learning is used in learning of the image feature amount extracting DNN. Here, the method for learning the image feature amount extracting DNN according to a comparative example is described with reference to FIGS. 4 and 5.

FIG. 4 is a diagram for explaining the method for learning the image feature amount extracting DNN according to the comparative example. Referring to FIG. 4, a learning query image G2 and a learning DB image G1 are shown. The learning device 20 obtains an image feature amount E2 output from the DNN, on the basis of the input of the learning query image G2 to the DNN. Further, the learning device 20 obtains an image feature amount E1 output from the DNN, on the basis of the input of the learning DB image G1 to the DNN.

In a feature amount space E, there exists the image feature amount E2 extracted from the learning query image G2. Further, in the feature amount space E, there exists the image feature amount E1 extracted from the learning DB image G1.

In the comparative example, in a case where a true value label is attached to the learning DB image G1, the DNN is learned so that the image feature amount E1 extracted from the learning DB image G1 approaches the image feature amount E2 extracted from the learning query image G2 (so that the image feature amount E1 moves in a direction D1). On the other hand, in a case where any true value label is not attached to the learning DB image G1, the DNN is learned so that the image feature amount E1 extracted from the learning DB image G1 moves away from the image feature amount E2 extracted from the learning query image G2 (so that the image feature amount E1 moves in a direction D2).

FIG. 5 is a diagram for explaining the problems of the comparative example. In the example illustrated in FIG. 5, an overlap region G11 between the learning query image G2 and the learning DB image G1 in the learning DB image G1, and a non-overlap region G12 that is a region other than the overlap region G11 in the learning DB image G1 are shown. In the comparative example, it is necessary to know whether or not the learning DB image G1 is correct in advance. Therefore, there is a first problem of human costs for creating true value labels.

Further, in a case where the learning DB image G1 is correct, the DNN is learned so that the image feature amount corresponding to the non-overlap region G12 with the learning query image G2 in the learning DB image G1 approaches the image feature amount corresponding to the learning query image G2. Therefore, in the comparative example, there is a second problem in that a confusion occurs in the learning of the DNN, and the learning of the DNN does not effectively proceed.

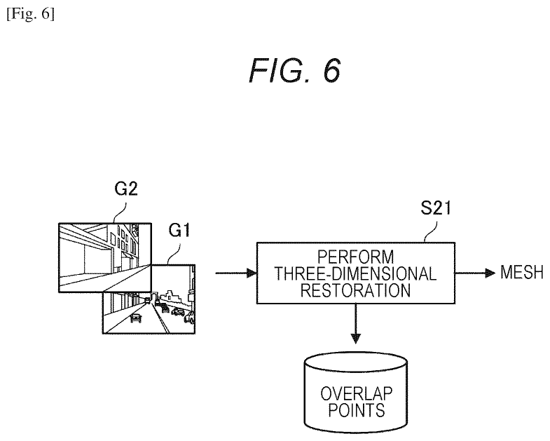

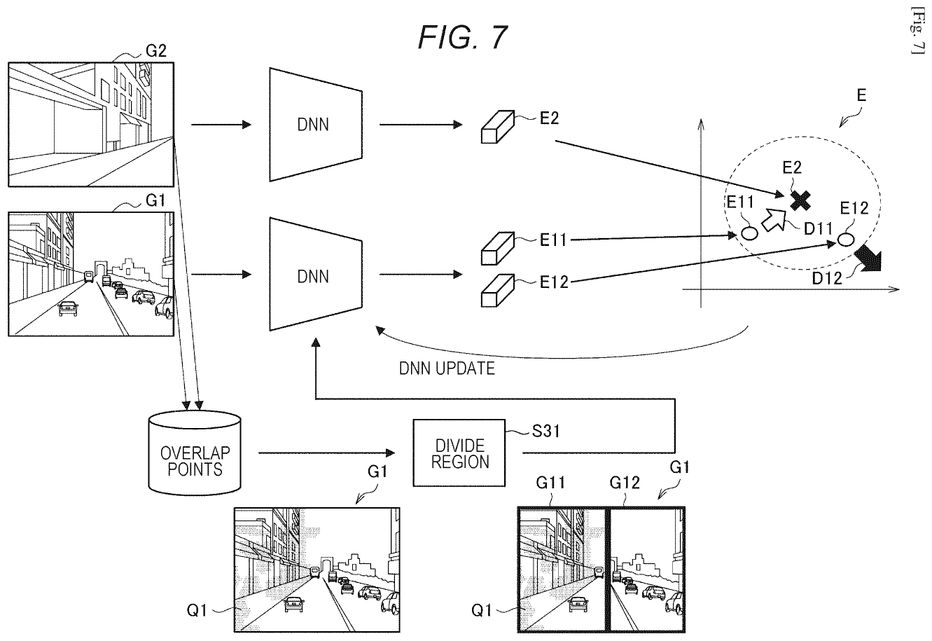

Next, a method for learning the image feature amount extracting DNN according to the embodiment of the present disclosure is described with reference to FIGS. 6 and 7.

FIG. 6 is a diagram illustrating the flow of the method for learning the image feature amount extracting DNN according to the embodiment of the present disclosure.

Referring to FIG. 6, a learning query image G2 and a learning DB image G1 are shown. In the embodiment of the present disclosure, the learning device 20 extracts an overlap region between the learning query image G2 and the learning DB image G1, on the basis of three-dimensional information related to the learning query image G2 and the learning DB image G1, for example. This can solve the problems of the comparative example.

For example, in a case where three-dimensional information is extracted only from images, a three-dimensional restoration technique for generating a three-dimensional model from the learning query image G2 and the learning DB image G1 can be used in determining an overlap region. That is, an overlap region can be determined on the basis of the overlap positions (hereinafter also referred to as “overlap points”) obtained in the process of three-dimensional restoration (S21).

FIG. 7 is a diagram for explaining the method for learning the image feature amount extracting DNN according to the embodiment of the present disclosure. Referring to FIG. 7, an overlap point Q1 is extracted from the learning DB image G1, and an overlap region G11 and a non-overlap region G12 are extracted on the basis of the overlap point Q1. Then, by region division S31, the image feature amount corresponding to the learning DB image G1 is divided into an image feature amount E11 corresponding to the overlap region G11 and an image feature amount E12 corresponding to the non-overlap region G12.

In the embodiment of the present disclosure, the learning device 20 learns the DNN so that the image feature amount E11 corresponding to the overlap region approaches the image feature amount E2 extracted from the learning query image G2 (so that the image feature amount E11 moves in a direction D11). Also, the DNN is learned so that the image feature amount E12 corresponding to the non-overlap region moves away from the image feature amount E2 extracted from the learning query image G2 (so that the image feature amount E12 moves in a direction D12).

As a result, in the embodiment of the present disclosure, the learning device 20 can automatically attach a true value label to the overlap region G11. This solves the first problem of the human costs for creating true value labels.

Furthermore, in the embodiment of the present disclosure, learning is performed so that the image feature amount extracted from the overlap region G11 approaches the image feature amount extracted from the learning query image G2, and the image feature amount extracted from the non-overlap region G12 moves away from the image feature amount extracted from the learning query image G2. This solves the second problem in that a confusion occurs in the learning of the DNN, and the learning of the DNN does not effectively proceed.

The above is the outline of the embodiment of the present disclosure.

### 1. Details of the Embodiment

Next, the embodiment of the present disclosure is described in detail.

### 1.1. Example Functional Configuration of the Terminal Device

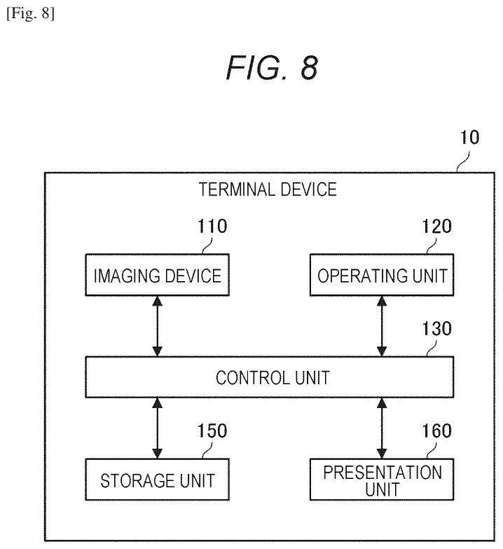

Next, an example functional configuration of the terminal device 10 according to the embodiment of the present disclosure is described mainly with reference to FIG. 8.

FIG. 8 is a diagram illustrating an example functional configuration of the terminal device 10 according to the embodiment of the present disclosure. As illustrated in FIG. 8, the terminal device 10 according to the embodiment of the present disclosure includes an imaging device 110, an operating unit 120, a control unit 130, a storage unit 150, and a presentation unit 160.

### Imaging Device 110

The imaging device 110 obtains an inference query image by capturing an image of an imaging range determined in accordance with the position and the posture of the imaging device 110 in the real space, on the basis of a predetermined imaging start operation input by the user. The imaging device 110 outputs the inference query image to the control unit 130. When the imaging device 110 outputs the inference query image to the control unit 130, processing corresponding to the inference query image is performed by the control unit 130.

### Operating Unit 120

The operating unit 120 has a function of receiving various kinds of operations input by the user. For example, the operating unit 120 may be formed with an input device such as a touch panel or buttons. The operating unit 120 outputs an operation input by the user to the control unit 130. When the operating unit 120 outputs such an operation to the control unit 130, processing corresponding to the operation is performed by the control unit 130.

### Control Unit 130

The control unit 130 may be formed with one or a plurality of central processing units (CPUs), for example. In a case where the control unit 130 is formed with a processing device such as a CPU, the processing device may be formed with an electronic circuit. The control unit 130 can be formed by the processing device executing a program.

For example, when the inference query image is input from the imaging device 110, the control unit 130 controls a communication unit (not shown in the drawings) so that the inference query image is transmitted to the inference device 30. Also, when device position/posture information is received from the inference device 30 by the communication unit (not shown), the control unit 130 controls the presentation unit 160 to dispose an AR object in an augmented reality space on the basis of the device position/posture information.

### Storage Unit 150

The storage unit 150 is a recording medium that includes a memory, and stores a program to be executed by the control unit 130 and the data necessary for executing the program. Also, the storage unit 150 temporarily stores data for calculation to be performed by the control unit 130. The storage unit 150 is formed with a magnetic storage device, a semiconductor storage device, an optical storage device, a magneto-optical storage device, or the like.

### Presentation Unit 160

The presentation unit 160 presents various kinds of information to the user, under the control of the control unit 130. For example, the presentation unit 160 is formed with a display, and displays an AR object under the control of the control unit 130.

The above is the description of an example functional configuration of the terminal device 10 according to the embodiment of the present disclosure.

### 1.2. Example Functional Configuration of the Inference Device

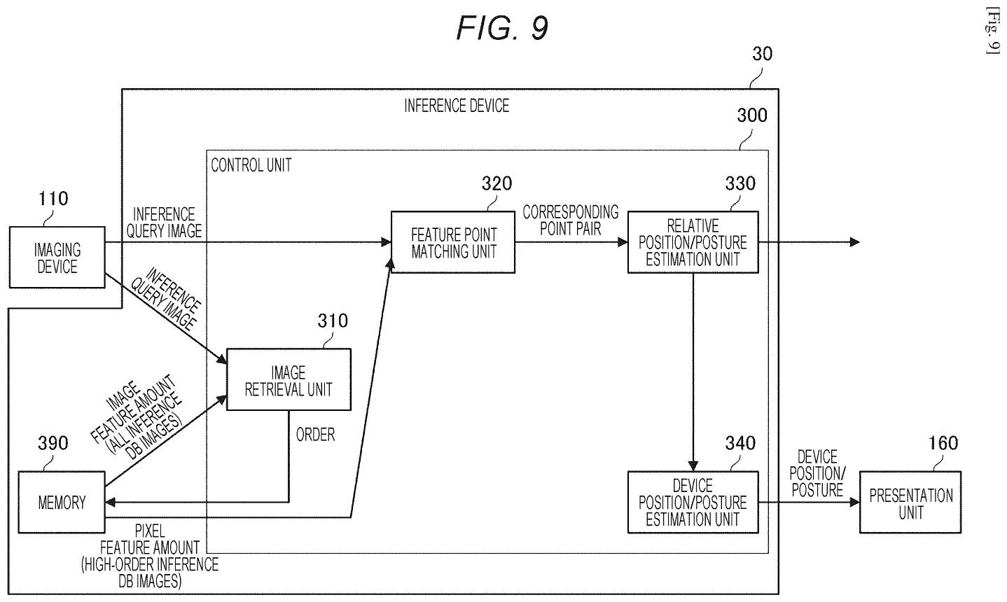

Next, an example functional configuration of the inference device 30 according to the embodiment of the present disclosure is described mainly with reference to FIGS. 9 to 11.

FIG. 9 is a diagram illustrating an example functional configuration of the inference device 30 according to the embodiment of the present disclosure. As illustrated in FIG. 9, the inference device 30 according to the embodiment of the present disclosure includes a control unit 300 and a memory 390. Furthermore, the control unit 300 includes an image retrieval unit 310, a feature point matching unit 320, a relative position/posture estimation unit 330, and a device position/posture estimation unit 340.

### Control Unit 300

The control unit 300 may be formed with one or a plurality of central processing units (CPUs), for example. In a case where the control unit 300 is formed with a processing device such as a CPU, the processing device may be formed with an electronic circuit. For the control unit 300, a program is executed by the processing device.

The control unit 300 extracts an image feature amount (first image feature amount) from an inference query image, using a model updated and obtained by training. The control unit 300 then estimates device position/posture information (first position/posture information) about the imaging device 110 at the time of capture of the inference query image, on the basis of the image feature amount extracted from the inference query image.

More specifically, from among the image feature amounts of the respective inference DB images, the control unit 300 specifies a predetermined number of image feature amounts as high-order inference DB images in ascending order of difference from the image feature amount extracted from the inference query image. The control unit 300 then estimates the device position/posture information about the imaging device 110 at the time of capture of the inference query image, on the basis of the high-order inference DB images (fourth images) and the inference query image.

As an example, the control unit 300 specifies, from among the high-order inference DB images, a second feature point having a pixel feature amount with the smallest difference from the pixel feature amount at a first feature point in the inference query image. The control unit 300 then estimates the device position/posture information about the imaging device 110 at the time of capture of the inference query image, on the basis of the two-dimensional coordinates of the first feature point in the inference query image, the two-dimensional coordinates of the second feature point in the high-order inference DB image, three-dimensional position information about the second feature point, and the device position/posture information corresponding to the high-order inference DB image.

### Memory 390

The memory 390 is a recording medium that stores a program to be executed by the control unit 300, and the data (such as various kinds of databases) necessary for executing the program. Also, the memory 390 temporarily stores data for calculation to be performed by the control unit 300. The memory 390 is formed with a magnetic storage device, a semiconductor storage device, an optical storage device, a magneto-optical storage device, or the like.

### Image Retrieval Unit 310

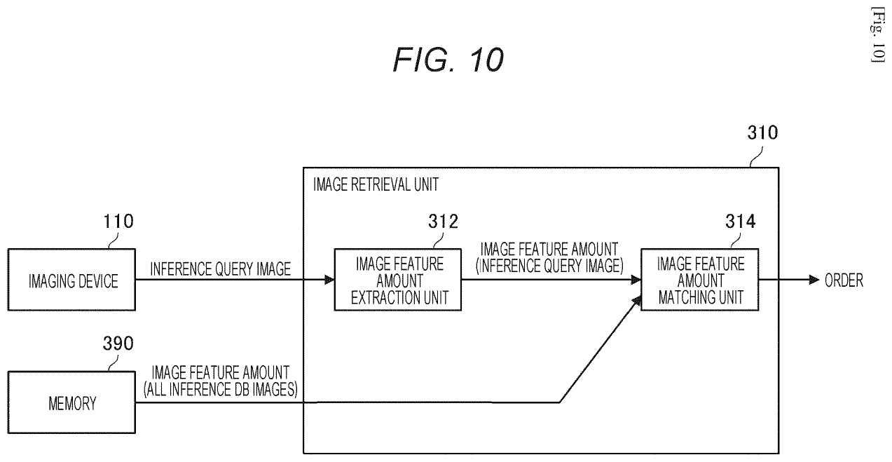

FIG. 10 is a diagram illustrating a specific example configuration of the image retrieval unit 310. As illustrated in FIG. 10, the image retrieval unit 310 includes an image feature amount extraction unit 312 and an image feature amount matching unit 314. Note that, as an example, the image feature amount extraction unit 312 can be a model that has been transmitted from the learning device 20 and been received by the communication unit (not shown) of the inference device 30.

The image feature amount extraction unit 312 acquires an inference query image from the imaging device 110 included in the terminal device 10. Further, the image feature amount extraction unit 312 extracts an image feature amount from the inference query image.

The image feature amount matching unit 314 acquires, from the memory 390, the image feature amount extracted from each inference DB image. The image feature amount matching unit 314 then calculates the difference between the image feature amount extracted from the inference query image and the image feature amount extracted from each inference DB image. The image feature amount matching unit 314 ranks all the inference DB images so that an inference DB image from which an image feature amount having a smaller difference from the image feature amount extracted from the inference query image is extracted is ranked higher.

From among the image feature amounts extracted from all the inference DB images, the image feature amount matching unit 314 specifies a predetermined number of image feature amounts in ascending order of difference from the image feature amount extracted from the inference query image. The inference DB images corresponding to the respective image feature amounts in the predetermined number of image feature amounts are high-order inference DB images.

### Feature Point Matching Unit 320

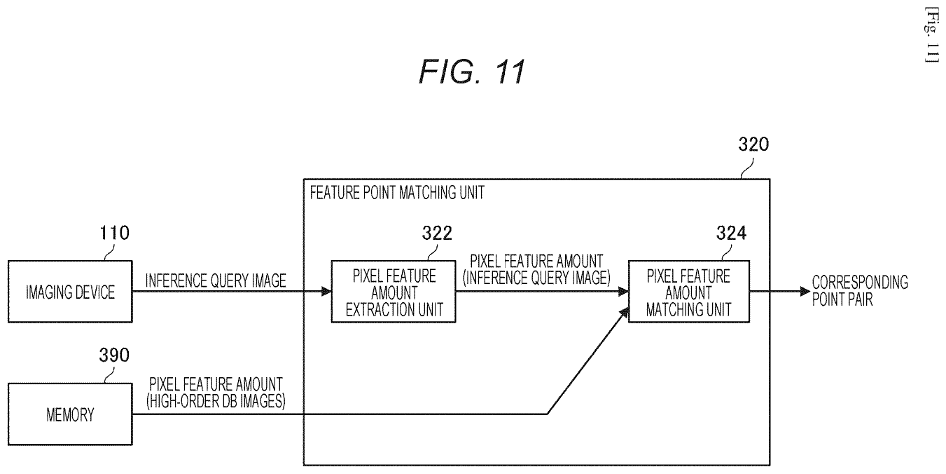

FIG. 11 is a diagram illustrating a specific example configuration of the feature point matching unit 320. As illustrated in FIG. 11, the feature point matching unit 320 includes a pixel feature amount extraction unit 322 and a pixel feature amount matching unit 324.

The pixel feature amount extraction unit 322 acquires the inference query image from the imaging device 110 included in the terminal device 10. Further, the pixel feature amount extraction unit 322 extracts pixel feature amounts from the inference query image. More specifically, the pixel feature amount extraction unit 322 detects a plurality of feature points from the inference query image, and calculates the pixel feature amounts at the feature points on the basis of peripheral pixel information about each feature point of the plurality of feature points. For the detection of the feature points and the extraction of the pixel feature amounts, a known method such as scale-invariant feature transform (SIFT) may be used, or a DNN method may be used, for example.

The pixel feature amount matching unit 324 acquires, from the memory 390, the image feature amount extracted from each high-order inference DB image. The pixel feature amount matching unit 324 then specifies, as a corresponding point pair, two feature points having the smallest difference in pixel feature amount, between the feature points (first feature points) extracted from the inference query image and the feature points (second feature points) extracted from the high-order inference DB images.

### Relative Position/Posture Estimation Unit 330

On the basis of the two-dimensional coordinates of each point of the corresponding point pair and the three-dimensional coordinates of the feature point in the high-order inference DB image in the corresponding point pair, the relative position/posture estimation unit 330 estimates relative position/posture information about the imaging device 110 at the time of capture of the inference query image, the reference being the device position/posture information corresponding to the high-order inference DB image. As the method for estimating the relative position/posture information about the imaging device 110, a known method such as the PnP algorithm is used.

### Device Position/Posture Estimation Unit 340

The device position/posture estimation unit 340 estimates the device position/posture information corresponding to the inference query image, on the basis of the device position/posture information corresponding to the inference DB image and the relative position/posture information about the imaging device at the time of capture of the inference query image, the reference being the device position/posture information corresponding to the high-order inference DB image. For example, the device position/posture information corresponding to the inference query image may be provided to the terminal device 10.

The above is the description of the example functional configuration of the inference device 30 according to the embodiment of the present disclosure.

### 1.3. Example Functional Configuration of the Learning Device

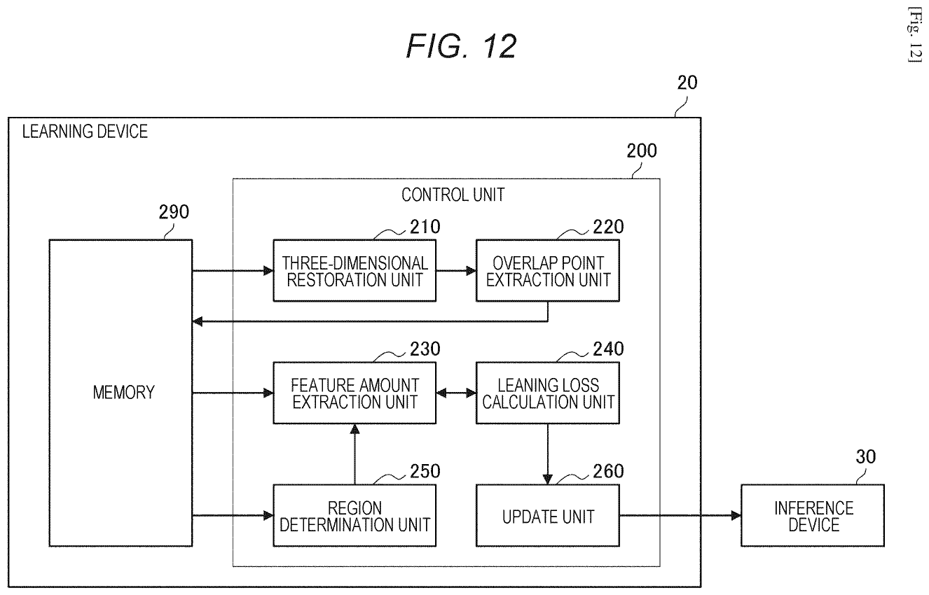

Next, an example functional configuration of the learning device 20 according to the embodiment of the present disclosure is described mainly with reference to FIGS. 12 to 21.

FIG. 12 is a diagram illustrating an example functional configuration of the learning device 20 according to the embodiment of the present disclosure. As illustrated in FIG. 12, the learning device 20 according to the embodiment of the present disclosure includes a control unit 200 and a memory 290. Furthermore, the control unit 200 includes a three-dimensional restoration unit 210, an overlap point extraction unit 220, a feature amount extraction unit 230, a learning loss calculation unit 240, a region determination unit 250, and an update unit 260.

### Control Unit 200

The control unit 200 may be formed with one or a plurality of central processing units (CPUs), for example. In a case where the control unit 200 is formed with a processing device such as a CPU, the processing device may be formed with an electronic circuit. The control unit 200 can be formed by the processing device executing a program.

### Memory 290

The memory 290 is a recording medium that stores a program to be executed by the control unit 200, and the data (such as various kinds of databases) necessary for executing the program. Also, the memory 290 temporarily stores data for calculation to be performed by the control unit 200. The memory 290 is formed with a magnetic storage device, a semiconductor storage device, an optical storage device, a magneto-optical storage device, or the like.

In the memory 290, a learning query image, and one or a plurality of learning DB images to be used for learning are stored in advance. In the description below, the one or the plurality of learning DB images will be referred to as “all the learning DB images” in some cases. Further, an image group in which the learning query image and all the learning DB images are combined will be referred to as “all the learning images” in some cases. Each learning DB image may correspond to an example of a first image. The learning query image may correspond to an example of a second image.

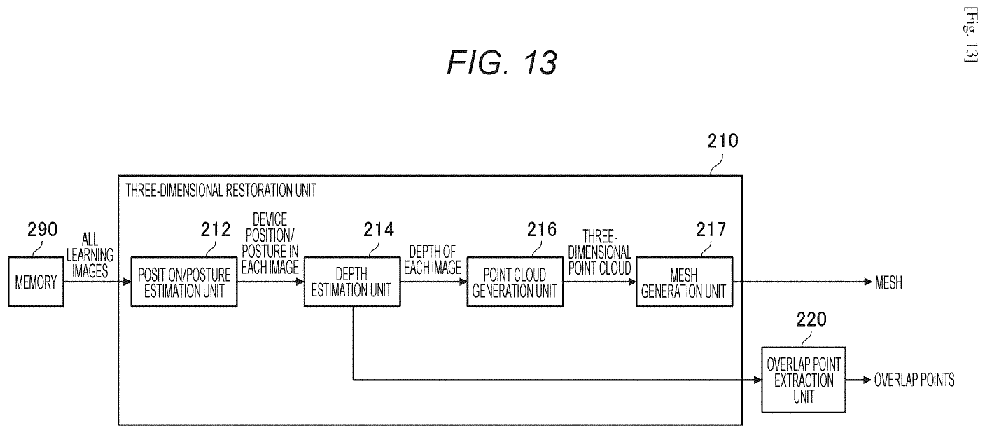

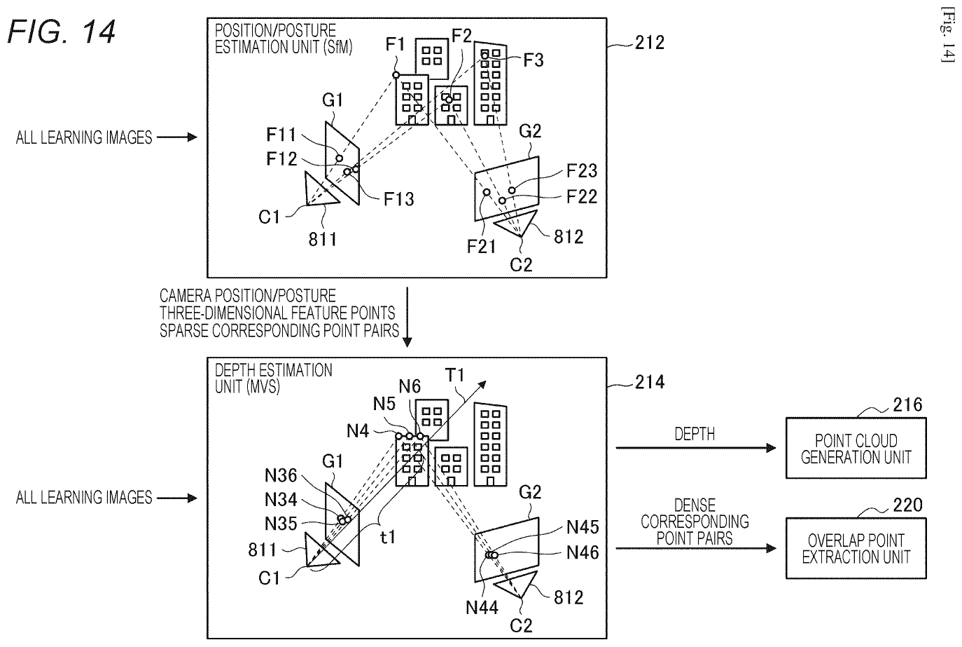

As will be described later, overlap points (overlap positions) between the learning query image and the learning DB images are extracted, and examples of a method for extracting overlap points include a first overlap point extraction method and a second overlap point extraction method. First, the first overlap point extraction method is described with reference to FIGS. 13 and 14.

### First Overlap Point Extraction Method

FIG. 13 is a diagram illustrating a specific example configuration of the three-dimensional restoration unit 210 according to the first overlap point extraction method. The three-dimensional restoration unit 210 generates a three-dimensional model on the basis of all the learning images. A three-dimensional restoration technique that is a known technique can be used in generating the three-dimensional model. As three-dimensional information related to all the learning images is obtained in the process of generating the three-dimensional model, overlap points can be extracted on the basis of the three-dimensional information.

By the first overlap point extraction method, the three-dimensional information to be used in extracting overlap points may include a three-dimensional feature point group calculated on the basis of sparse corresponding point pairs between each two images among all the learning images.

As illustrated in FIG. 13, the three-dimensional restoration unit 210 includes a position/posture estimation unit 212, a depth estimation unit 214, a point cloud generation unit 216, and a mesh generation unit 217. Here, the respective functions of the position/posture estimation unit 212 and the depth estimation unit 214 are described with reference to FIG. 14.

FIG. 14 is a diagram for explaining the respective functions of the position/posture estimation unit 212 and the depth estimation unit 214. The position/posture estimation unit 212 estimates the device position/posture information corresponding to each learning image on the basis of all the learning images, and calculates a three-dimensional feature point group existing in the real space and sparse corresponding point pairs (covisibility graph) between each two images among all the learning images.

As the method for estimating the device position/posture information corresponding to each learning image on the basis of all the learning images and calculating the three-dimensional feature point group and the corresponding point pairs as described above, a known method sch as the structure from motion (SfM) can be used. The example case illustrated in FIG. 14 is based on the assumption that the learning DB image G1 and the learning query image G2 are included in all the learning images. Note that an origin C1 is the viewpoint of an imaging device 811, and an origin C2 is the viewpoint of an imaging device 812.

Here, an example method by which the position/posture estimation unit 212 estimates the device position/posture information corresponding to each learning image and calculates a three-dimensional feature point group and corresponding point pairs is briefly described. First, the position/posture estimation unit 212 calculates corresponding point pairs between the learning DB image GI and the learning query image G2, on the basis of the learning DB image G1 and the learning query image G2. Here, the method for calculating the corresponding point pairs is not limited to any particular method.

As an example, the position/posture estimation unit 212 may extract a pixel feature amount from each of the learning DB image G1 and the learning query image G2. The position/posture estimation unit 212 may then perform matching between the pixel feature amounts of the respective pixels of the learning DB image G1 and the pixel feature amounts of the respective pixels of the learning query image G2, to calculate corresponding point pairs of pixels having the smallest difference in pixel feature amount between the learning DB image G1 and the learning query image G2.

In the example illustrated in FIG. 14, the combination of a feature point F11 in the learning DB image G1 and a feature point F21 in the learning query image G2 is a corresponding point pair. Also, the combination of a feature point F12 in the learning DB image G1 and a feature point F22 in the learning query image G2 is a corresponding point pair. Further, the combination of a feature point F13 in the learning DB image G1 and a feature point F23 in the learning query image G2 is a corresponding point pair.

Furthermore, on the basis of the corresponding point pairs, the position/posture estimation unit 212 calculates, as provisional calculation results, position/posture information (first position/posture information) about the imaging device 811 (first imaging device) at the time of capture of the learning DB image G1, position/posture information (second position/posture information) about the imaging device 812 (second imaging device) at the time of capture of the learning query image G2, and three-dimensional feature point groups F1 to F3, by triangulation. Likewise, the position/posture estimation unit 212 then performs provisional calculation between other two images among all the learning images, and updates the device position/posture information, the three-dimensional feature point groups, and the corresponding point pairs corresponding to the respective learning images by bundle adjustment so that the provisional calculation results are consistent between each two images. The updated corresponding point pairs corresponds to the sparse corresponding point pairs described above.

The depth estimation unit 214 calculates the depth of each pixel in each learning image and dense corresponding point pairs (consistency graph) between each two images among all the learning images, on the basis of all the learning images, the device position/posture information corresponding to each learning image, the three-dimensional feature point groups, and the sparse corresponding point pairs.

As the method for calculating the depth of each pixel in each learning image on the basis of all the learning images, the device position/posture information corresponding to each learning image, the three-dimensional feature point groups, and the sparse corresponding point pairs as described above, a known method such as multi view stereo (MVS) can be used.

Here, an example of the method by which the depth estimation unit 214 calculates the depth of each pixel in each learning image is briefly described. First, the depth estimation unit 214 selects a pair of two images in which the same three-dimensional feature point is captured, on the basis of all the learning images, the three-dimensional feature point groups, and the sparse corresponding point pairs.

At this point of time, if the angle between the two images is too small, it is also predicted that the depth of each pixel by triangulation will not be calculated with high accuracy. Therefore, the depth estimation unit 214 may calculate the angle between the two images on the basis of the device position/posture information corresponding to each of the two images and the three-dimensional feature point groups, and limit the angle between the two images to an angle that is equal to or greater than a predetermined angle. In other words, the depth estimation unit 214 may not select two images that form an angle that is smaller than the predetermined angle.

The depth estimation unit 214 then performs pixel matching that is block matching between the two images, and calculates a corresponding point pair for each pixel between the two images. The corresponding point pairs calculated herein correspond to the dense corresponding point pairs mentioned above.

In the example illustrated in FIG. 14, the combination of a point N34 in the learning DB image G1 and a point N44 in the learning query image G2 is a corresponding point pair, and corresponds to a three-dimensional point N4. Further, the combination of a point N35 in the learning DB image G1 and a point N45 in the learning query image G2 is also a corresponding point pair, and corresponds to a three-dimensional point N5. Furthermore, the combination of a point N36 in the learning DB image G1 and a point N46 in the learning query image G2 is also a corresponding point pair, and corresponds to a three-dimensional point N6.

The depth estimation unit 214 calculates the depth of each pixel in each learning image by triangulation, on the basis of the device position/posture information corresponding to each learning image and the dense corresponding point pairs. FIG. 14 shows a depth direction T1 from the origin C1 of the imaging device 811 toward the front of the imaging device 811 in the learning DB image G1. Also, a depth t1 with respect to the origin C1 (reference position) of the imaging device 811 at the point N35 in the learning DB image G1 is shown.

The depth estimation unit 214 outputs the depth of each pixel in each learning image to the point cloud generation unit 216. Further, the depth estimation unit 214 outputs the device position/posture information corresponding to each learning image, to the point cloud generation unit 216. Meanwhile, the depth estimation unit 214 outputs the dense corresponding point pairs to the overlap point extraction unit 220.

The point cloud generation unit 216 generates a three-dimensional point group by integrating the depths of the respective pixels in the respective learning images, on the basis of the depths of the respective pixels in the respective learning images and the device position/posture information corresponding to the respective learning images. The method for obtaining a three-dimensional point group by integrating the depths of the respective pixels in the respective images in this manner is also called Fusion.

The mesh generation unit 217 generates a mesh, on the basis of the three-dimensional point group generated by the point cloud generation unit 216. Various kinds of mesh generation techniques that are known methods can be used by the mesh generation unit 217 to generate a mesh.

The overlap point extraction unit 220 determines the presence/absence of an overlap point between the learning query image and each learning DB image. More specifically, the overlap point extraction unit 220 determines the presence/absence of an overlap point between the learning query image and each learning DB image, on the basis of three-dimensional information related to all the learning images.

By the first overlap point extraction method, the overlap point extraction unit 220 acquires the dense corresponding point pairs from the depth estimation unit 214. The overlap point extraction unit 220 then extracts overlap points that are pixels serving as the points corresponding to the pixels in the learning query image among the pixels in the learning DB images, on the basis of the corresponding points.

When an overlap point is extracted from a learning DB image, the overlap point extraction unit 220 determines that there is an overlap point between the learning DB image and the learning query image. When any overlap point is not extracted from a learning DB image, on the other hand, the overlap point extraction unit 220 determines that there are no overlap points between the learning DB image and the learning query image.

Note that the overlap point extraction unit 220 may remove an erroneously detected corresponding point as a noise point from the dense corresponding point pairs acquired from the depth estimation unit 214, and extract overlap points on the basis of the corresponding points that have not been removed. For example, in a case where the number of corresponding points within a predetermined range around a target pixel (such as a range of 3×3 pixels centering around the target pixel, for example) is equal to or smaller than a threshold, the target pixel may be determined to be a noise point.

### Second Overlap Point Extraction Method

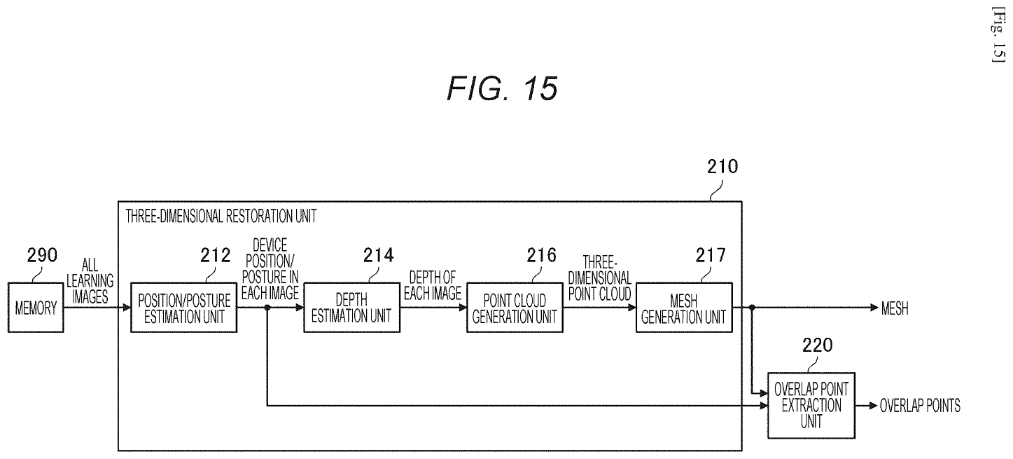

Next, the second overlap point extraction method is described with reference to FIGS. 15 to 19.

FIG. 15 is a diagram illustrating a specific example configuration of the three-dimensional restoration unit 210 according to the second overlap point extraction method. By the second overlap point extraction method, the three-dimensional restoration unit 210 also generates a three-dimensional model on the basis of all the learning images as in an operation by the first overlap point extraction method. By the second overlap point extraction method, three-dimensional information related to all the learning images is also obtained in the process of generating the three-dimensional model, and thus, overlap points can be extracted on the basis of the three-dimensional information.

As illustrated in FIG. 15, by the second overlap point extraction method, the position/posture estimation unit 212 outputs the device position/posture information corresponding to each learning image, to the overlap point extraction unit 220. Further, the mesh generation unit 217 outputs a generated mesh to the overlap point extraction unit 220.

Here, by the second overlap point extraction method, the three-dimensional information to be used in extracting overlap points may include information based on the device position/posture information corresponding to each learning DB image and the device position/posture information corresponding to the learning query image.

More specifically, the information based on the device position/posture information corresponding to each learning DB image and the device position/posture information corresponding to the learning query image may include the coordinates of a three-dimensional point (first three-dimensional point) in the real space and the coordinates of a three-dimensional point (second three-dimensional point) in the real space. Also, the three-dimensional information to be used in extracting overlap points may include the normal directions with respect to the object surface at these three-dimensional points.

The three-dimensional point group in the real space and the normal directions with respect to the object surface at the three-dimensional points are included in the mesh generated by the mesh generation unit 217. The overlap point extraction unit 220 extracts overlap points, on the basis of the mesh generated by the mesh generation unit 217 and the device position/posture information corresponding to each learning image.

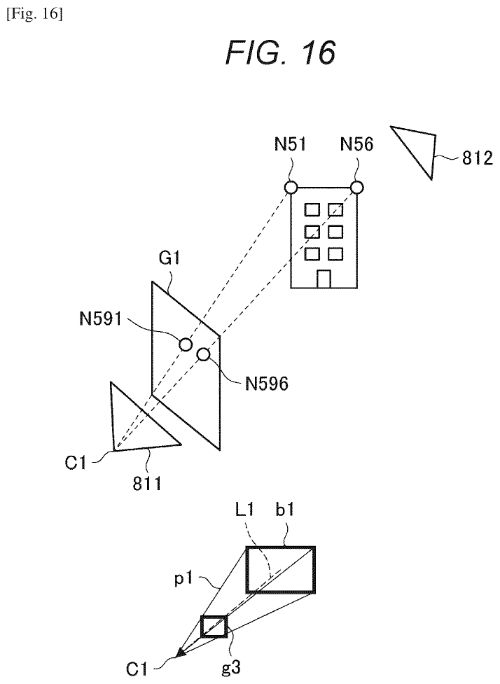

FIG. 16 is a diagram of a three-dimensional point group as viewed obliquely from a side. Referring to FIG. 16, a three-dimensional point N51 and a three-dimensional point N56 exist in real space. The coordinates of the three-dimensional point N51 and the coordinates of the three-dimensional point N56 are included in a mesh that is output from the mesh generation unit 217 to the overlap point extraction unit 220.

Further, referring to FIG. 16, the imaging device 811 that has captured a learning DB image G1 is shown. The device position/posture information about the imaging device 811 at the time of capture of the learning DB image G1 is output from the position/posture estimation unit 212 to the overlap point extraction unit 220. Furthermore, an imaging device 812 whose front direction is opposite to the front direction of the imaging device 811 is also shown.

Here, the learning DB image G1 is projected from the real space onto a vertical plane with respect to the front direction, the vertical plane being located at a position separated from the imaging device 811 by the focal length in the front direction. The overlap point extraction unit 220 calculates a quadrangular pyramid p1 (a quadrangular pyramid in which the origin C1 is a vertex, the center-of-gravity line L1 is the axis, and a surface b1 is the bottom surface) that is surrounded by straight lines drawn from the origin C1 of the imaging device 811 toward the four corners of a pixel g3 in the learning DB image G1.

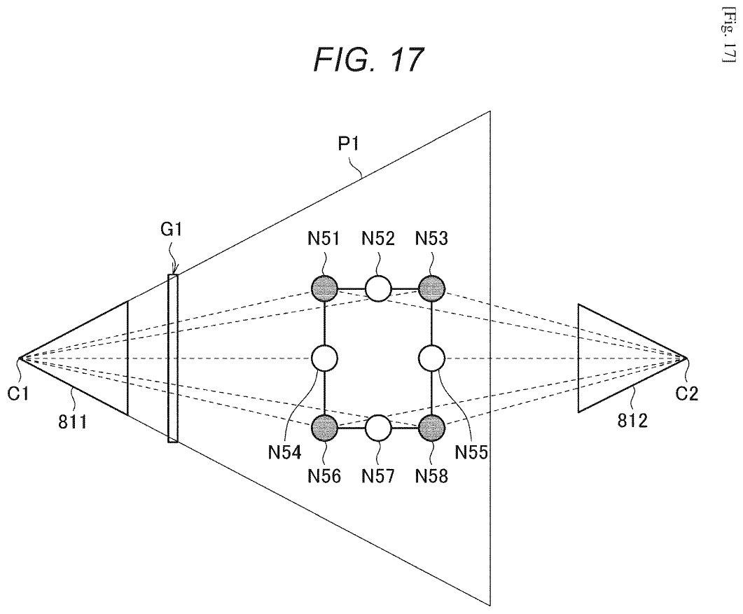

FIG. 17 is a diagram of the three-dimensional point group as viewed from above. FIG. 17 shows a quadrangular pyramid P1 surrounded by straight lines drawn from the origin C1 of the imaging device 811 toward the four corners of the learning DB image. Three-dimensional points N51 to N58 exist inside the quadrangular pyramid P1.

At this point of time, it is also conceivable that the overlap point extraction unit 220 calculates all the three-dimensional points N51 to N58 that first appear inside the quadrangular pyramid P1 viewed from the origin C1, as points visible from the imaging device 811. However, the angle between the direction from the three-dimensional point N52 toward the origin C1 and the normal direction with respect to the object surface at the three-dimensional point N52 is 90 degrees or greater, and therefore, it can be assumed that the three-dimensional point N52 is not visible from the origin C1. It can likewise be assumed that the three-dimensional points N53, N55, N57, and N58 are not visible from the origin C1.

In view of this, in a case where the angle between the direction from a three-dimensional point toward the origin C1 and the normal direction with respect to the object surface at the three-dimensional point is 90 degrees or greater, it is desirable that the overlap point extraction unit 220 does not set the three-dimensional point as a point visible from the imaging device 811. As a result, the possibility that an overlap point is erroneously extracted on the basis of visible points can be lowered. Note that the normal directions with respect to the object surface at three-dimensional points can also be included in the mesh output from the mesh generation unit 217.

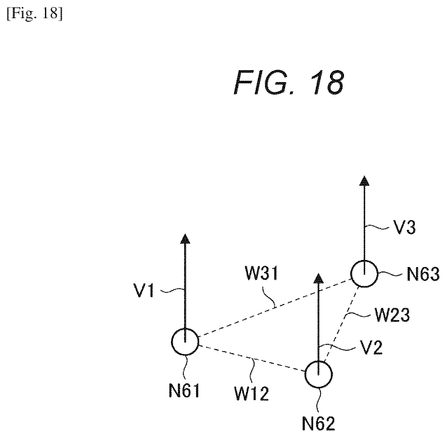

FIG. 18 is a diagram illustrating an example of a mesh. Referring to FIG. 18, a mesh including three-dimensional points N61 to N63 is shown. Each of the three-dimensional points N61 to N63 may also be expressed as a vertex. Also, line segments W12, W23, and W31 connecting each two points of the three-dimensional points N61 to N63 are shown. Normal directions V1 to V3 with respect to the object surface at the three-dimensional points N61 to N63 may also be included in the mesh.

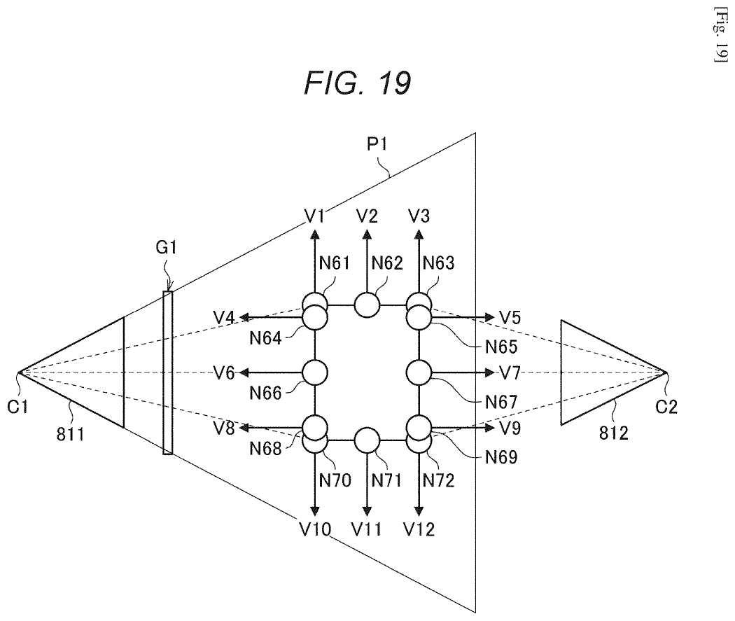

FIG. 19 is a diagram for explaining a case where overlap points are extracted on the basis of mesh information. In the example illustrated in FIG. 19, three-dimensional points N61 to N72 exist inside a quadrangular pyramid P1. Also, normal directions V1 to V12 with respect to the object surface at the three-dimensional points N61 to N72 are shown.

Here, the angle between the direction from the three-dimensional point N61 toward the origin C1 and the normal direction V1 with respect to the object surface at the three-dimensional point N61 is 90 degrees or greater. Accordingly, the overlap point extraction unit 220 does not need to set the three-dimensional point N61 as a point visible from the imaging device 811. Likewise, the overlap point extraction unit 220 may not set the three-dimensional points N62, N63, N65, N67, N69, and N70 to N72 as points visible from the imaging device 811. Meanwhile, the overlap point extraction unit 220 may set the three-dimensional points N64, N66, and N68 as visible points.

Likewise, the three-dimensional points N65, N67, and N69 may be set as points visible from the imaging device 812. Then, in a case where the same three-dimensional point is included between the points visible from the imaging device 811 and the points visible from the imaging device 812, the overlap point extraction unit 220 may extract the three-dimensional point as an overlap point between a learning DB image captured by the imaging device 811 and the learning query image captured by the imaging device 812.

In this manner, the overlap point extraction unit 220 extracts overlap points between each learning DB image and the learning query image. The overlap point extraction unit 220 stores the extracted overlap points into the memory 290. The overlap points stored in the memory 290 are acquired by the region determination unit 250, and the overlap region corresponding to the overlap points is determined by the region determination unit 250.

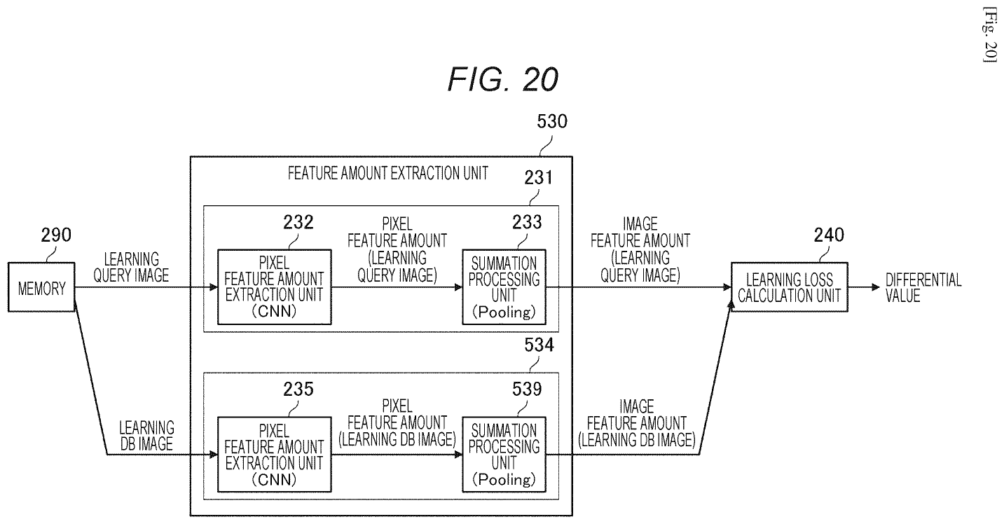

In the embodiment of the present disclosure, training based on an overlap region and a non-overlap region determined by the region determination unit 250 is performed. With a model obtained by such learning, an image feature amount is extracted from the inference query image with higher accuracy. To facilitate understanding of the advantage of the learning method according to the embodiment of the present disclosure, an example of a learning method according to a comparative example is first described with reference to FIG. 20.

### Feature Amount Extraction Unit 530 According to a Comparative Example

FIG. 20 is a diagram illustrating a specific example configuration of a feature amount extraction unit 530 according to a comparative example. The feature amount extraction unit 530 is formed with a DNN. As illustrated in FIG. 20, the feature amount extraction unit 530 according to the comparative example includes a learning query image feature amount extraction unit 231 and a learning DB image feature amount extraction unit 534. The learning query image feature amount extraction unit 231 includes a pixel feature amount extraction unit 232 and a summation processing unit 233. Meanwhile, the learning DB image feature amount extraction unit 534 includes a pixel feature amount extraction unit 235 and a summation processing unit 539.

The pixel feature amount extraction unit 232 is formed with a convolutional neural network (CNN). For example, the pixel feature amount extraction unit 232 acquires a learning query image from the memory 290, and extracts the pixel feature amount of each of the pixels constituting the learning query image (or each pixel after resolution reduction). Such pixel feature amounts may be expressed by vectors.

The summation processing unit 233 is formed with a pooling layer. For example, the summation processing unit 233 generates an image feature amount (second image feature amount) of the learning query image, by summing the pixel feature amounts of the respective pixels extracted from the learning query image by the pixel feature amount extraction unit 232.

Here, as the method for summing the pixel feature amounts, various methods can be assumed. For example, the method for summing the pixel feature amounts may be a method for outputting the maximum value among the pixel feature amounts of the respective pixels as a representative value, may be a method for clustering the pixel feature amounts of the respective pixels, summing the pixel feature amounts of each cluster, and combining the sums of the respective clusters into one vector, or may be some other known method.

Like the pixel feature amount extraction unit 232, the pixel feature amount extraction unit 235 is formed with a CNN. For example, the pixel feature amount extraction unit 235 acquires a learning DB image from the memory 290, and extracts the pixel feature amount of each of the pixels constituting the learning DB image (or each pixel after resolution reduction). Such pixel feature amounts may be expressed by vectors.

Like the summation processing unit 233, the summation processing unit 539 is formed with a pooling layer. For example, the summation processing unit 539 generates an image feature amount (first image feature amount) of the learning DB image, by summing the pixel feature amounts of the respective pixels extracted from the learning DB image by the pixel feature amount extraction unit 235.

The learning loss calculation unit 240 calculates a differential value for updating the DNN forming the feature amount extraction unit 530, on the basis of the image feature amount extracted from the learning query image and the image feature amount extracted from the learning DB image. Such a differential value can also be referred to as a “gradient”. Here, a learning loss according to a known method may be used in calculating a learning loss (loss function) for calculating the differential value. As an example, a method called triplet loss may be used in calculating a learning loss.

By such a method, in a case where an overlap region that overlaps with at least a partial region of the learning query image exists in a learning DB image, the differential value for updating the DNN is calculated so that the image feature amount extracted from the overlap region in the learning DB image approaches the image feature amount extracted from the image query image, and that the image feature amount extracted from the non-overlap region in the learning DB image moves away from the image feature amount extracted from the image query image.

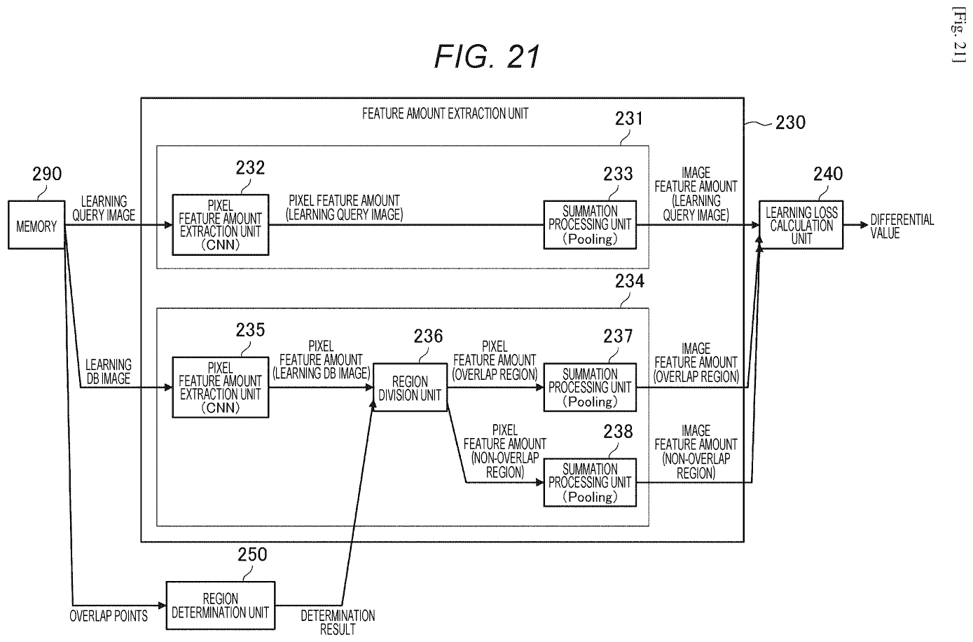

In the comparative example, however, it is normally assumed that information (which is a true value label) indicating which region in the learning DB image is the overlap region is attached manually, not automatically. On the other hand, in the embodiment of the present disclosure, information indicating which region is the overlap region is automatically attached. Next, an example of the learning method according to the embodiment of the present technology is described with reference to FIG. 21.

### Feature Amount Extraction Unit 230 According to the Embodiment of the Present Disclosure

FIG. 21 is a diagram illustrating a specific example configuration of the feature amount extraction unit 230 according to the embodiment of the present disclosure. Like the feature amount extraction unit 530 according to the comparative example, the feature amount extraction unit 230 according to the embodiment of the present disclosure is formed with a DNN. As illustrated in FIG. 21, like the feature amount extraction unit 530, the feature amount extraction unit 230 includes a learning query image feature amount extraction unit 231. Further, the feature amount extraction unit 230 includes a learning DB image feature amount extraction unit 234, instead of the learning DB image feature amount extraction unit 534. Note that the feature amount extraction unit 230 may correspond to an example of an extraction unit.

Like the learning DB image feature amount extraction unit 534, the learning DB image feature amount extraction unit 234 includes a pixel feature amount extraction unit 235. Further, the learning DB image feature amount extraction unit 234 includes a region division unit 236, a summation processing unit 237, and a summation processing unit 238, instead of the summation processing unit 539. The region division unit 236 receives a determination result from the region determination unit 250 included in the learning device 20.

The region determination unit 250 acquires overlap points from the memory 290. The region determination unit 250 then determines an overlap region corresponding to the overlap points, on the basis of the overlap points acquired from the memory 290. As an example, the region determination unit 250 may determine a pixel at which an overlap point is present in a learning DB image to be an overlap region. However, in a case where overlap points are sparsely present, overlap regions might also be sparsely present.

Therefore, the region determination unit 250 may determine a rectangular region including overlap points in a learning DB image to be an overlap region. Alternatively, while determining a set of pixels at which overlap points are present in the learning DB image to be a provisional overlap region, the region determination unit 250 may apply a median filter to the provisional overlap region so as to exclude, from the overlap region, pixels existing in a region where the density of overlap points is lower than a predetermined density.

The region determination unit 250 outputs a determination result indicating which region is an overlap region in the learning DB image, to the region division unit 236.

On the basis of the determination result output from the region determination unit 250, the region division unit 236 divides the pixel feature amounts extracted from the learning DB image into the pixel feature amounts of the respective pixels belonging to the overlap region and the pixel feature amounts of the respective pixels belonging to the non-overlap region. The region division unit 236 then outputs the pixel feature amounts of the respective pixels belonging to the overlap region to the summation processing unit 237, and outputs the pixel feature amounts of the respective pixels belonging to the non-overlap region to the summation processing unit 238.

Like the summation processing unit 539, the summation processing unit 237 is formed with a pooling layer. For example, the summation processing unit 237 generates the image feature amount (overlap region feature amount) corresponding to the overlap region, by summing the pixel feature amounts of the respective pixels belonging to the overlap region output from the region division unit 236. The summation processing unit 237 outputs the image feature amount corresponding to the overlap region, to the learning loss calculation unit 240.

Like the summation processing unit 237, the summation processing unit 238 is formed with a pooling layer. For example, the summation processing unit 238 sums the pixel feature amounts of the respective pixels belonging to the non-overlap region output from the region division unit 236, to generate the image feature amount (non-overlap region feature amount) corresponding to the non-overlap region. The summation processing unit 238 outputs the image feature amount corresponding to the non-overlap region, to the learning loss calculation unit 240.

### Learning Loss Calculation Unit 240

The learning loss calculation unit 240 calculates a differential value for updating the DNN forming the feature amount extraction unit 230, on the basis of the image feature amount of the learning query image, the image feature amount corresponding to the overlap region, and the image feature amount corresponding to the non-overlap region. Here, a learning loss according to a known method may be used in calculating a learning loss for calculating the differential value. As an example, a method called triplet loss may be used in calculating a learning loss.

More specifically, the learning loss calculation unit 240 calculates a differential value for updating the DNN so that the image feature amount corresponding to the overlap region and the image feature amount of the learning query image approach each other, and the image feature amount corresponding to the non-overlap region and the image feature amount corresponding to the learning query image move away from each other. The learning loss calculation unit 240 outputs the differential value to the update unit 260 (FIG. 12).

### Update Unit 260

The update unit 260 updates the DNN, on the basis of the differential value output from the learning loss calculation unit 240. More specifically, the update unit 260 updates the weight parameters forming the DNN by backpropagation, on the basis of the differential value output from the learning loss calculation unit 240. Such update of the DNN is repeatedly performed for all the learning DB images.

The feature amount extraction unit 230 formed with the updated DNN is transmitted to the inference device 30 via the network 40, and is used as the image feature amount extraction unit 312 in the inference device 30. The image feature amount extraction unit 312 is capable of extracting an image feature amount from the inference query image with higher accuracy.

The above is the description of the example functional configuration of the learning device 20 according to the embodiment of the present disclosure.

### 2. Various Modifications

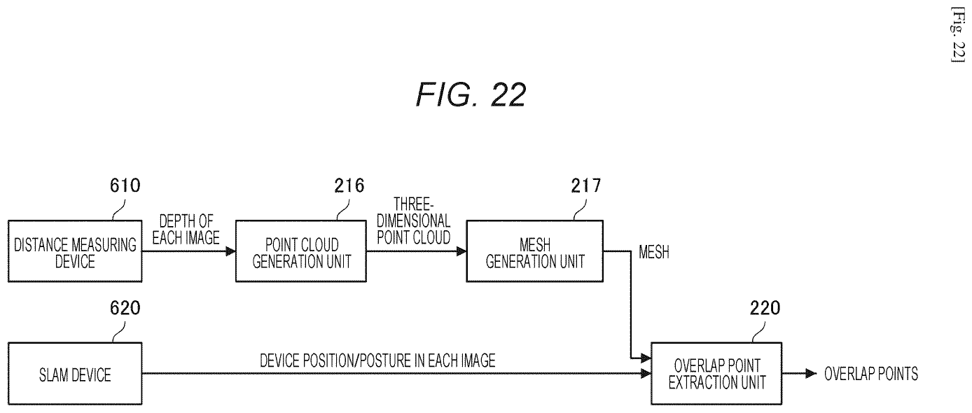

Next, various modifications of the information processing system 1 according to the embodiment of the present disclosure are described with reference to FIGS. 22 to 25.

### First Modification

FIG. 22 is a diagram for explaining a first modification. In the above description, an example in which the depth of each pixel in each learning image is estimated on the basis of all the learning images has been explained. However, the depth of each pixel in each learning image is not necessarily estimated only from images. For example, as illustrated in FIG. 22, the depth of each pixel in each learning image may be measured by a distance measuring device 610.

Note that, as for the type of the distance measuring device 610, any of various sensors can be used. For example, the distance measuring device 610 may be a light detection and ranging (LiDAR) sensor, a stereo depth sensor, or some other distance measuring device.

Also, in the above description, an example in which the device position/posture information corresponding to each learning image is estimated on the basis of all the learning images has been explained. However, the device position/posture information corresponding to each learning image is not necessarily estimated only from images. For example, as illustrated in FIG. 22, the device position/posture information corresponding to each learning image may be measured by a SLAM device 620 (a self-localization device).

Note that, as for the type of the sensor forming the SLAM device 620, any of various sensors can be used. For example, the SLAM device 620 may include a camera, or may include a combination of a camera and an inertial measurement unit (IMU) sensor.

### Second Modification

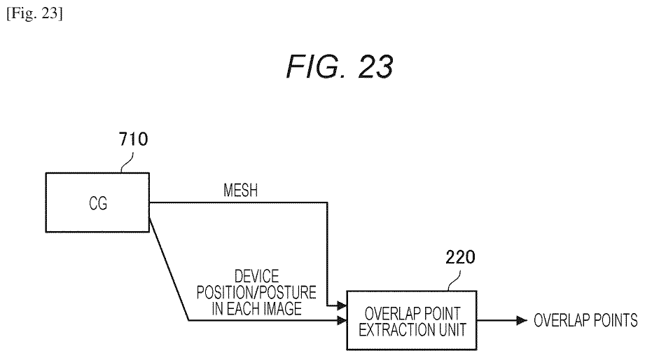

FIG. 23 is a diagram for explaining a second modification. In the above description, an example in which the three-dimensional restoration unit 210 outputs, to the overlap point extraction unit 220, a mesh and the device position/posture information corresponding to each learning image on the basis of all the learning images has been explained. However, a computer graphics (CG) 710 may output a mesh and the device position/posture information corresponding to each learning image to the overlap point extraction unit 220, on the basis of all the learning images.

The CG 710 is a program for generating a three-dimensional model. Such a three-dimensional model is disposed in a virtual space. At this point of time, a learning DB image may be an image based on a predetermined position/posture (first viewpoint) in the virtual space, and the learning query image may be an image based on a predetermined position/posture (second viewpoint) in the virtual space. Further, the coordinates of three-dimensional point groups in the real space may be acquired from a three-dimensional model generated by the mesh generation unit 217.

Note that the device position/posture information corresponding to a learning DB image may correspond to position/posture information about a virtual imaging device at the time of capture of the learning DB image in the virtual space. Likewise, the device position/posture information corresponding to the learning query image may correspond to position/posture information about the virtual imaging device at the time of capture of the learning query image in the virtual space.

### Third Modification

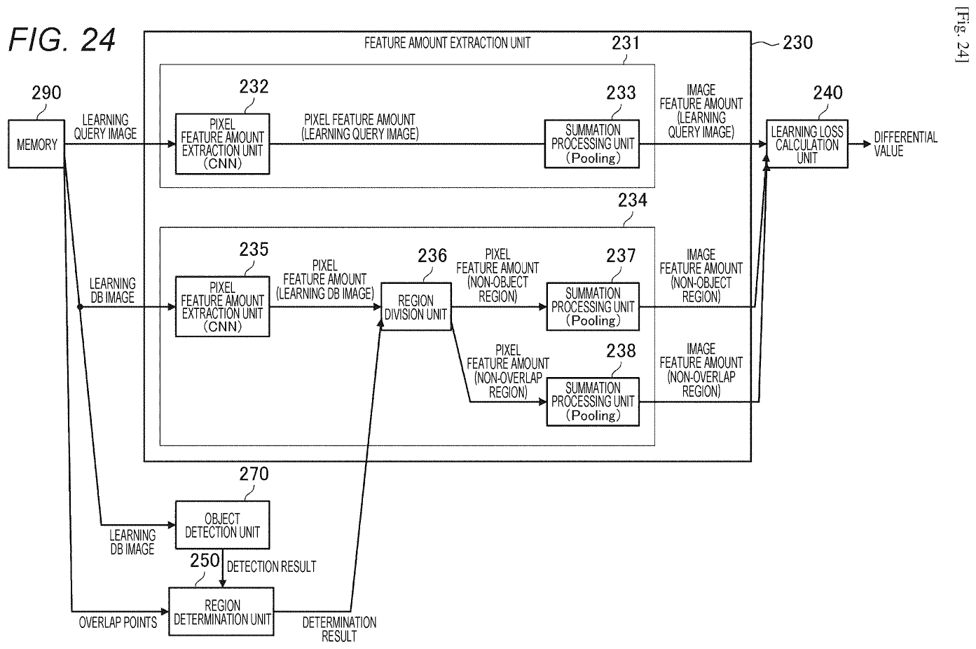

FIG. 24 is a diagram for explaining a third modification. In the above description, an example in which the learning of the feature amount extraction unit 230 is performed on the basis of an overlap region and a non-overlap region has been explained. However, in a case where a predetermined object does not appear in the learning query image, for example, if the predetermined object appears in the overlap region, there is a possibility that confusion occurs in learning, and the learning does not proceed effectively.

Note that the predetermined object may be a moving object (such as a person or a car, for example). Alternatively, since a mirror image reflected in glass might adversely affect learning, the predetermined object may be glass or the like. Alternatively, the predetermined object may be a non-unique object such as the sky.

Therefore, the learning of the feature amount extraction unit 230 may be performed on the basis of the image feature amount corresponding to a non-object region obtained by excluding, from the overlap region, the object region including the region in which the predetermined object is detected, and the image feature amount corresponding to the non-overlap region. Note that the predetermined object may be detected by a semantic segmentation DNN (or a DNN capable of detecting the predetermined object at pixel pitch).

As illustrated in FIG. 24, the predetermined object may be detected by an object detection unit 270. The result of the object detection performed by the object detection unit 270 may be then used by the region determination unit 250 to determine the overlap region.

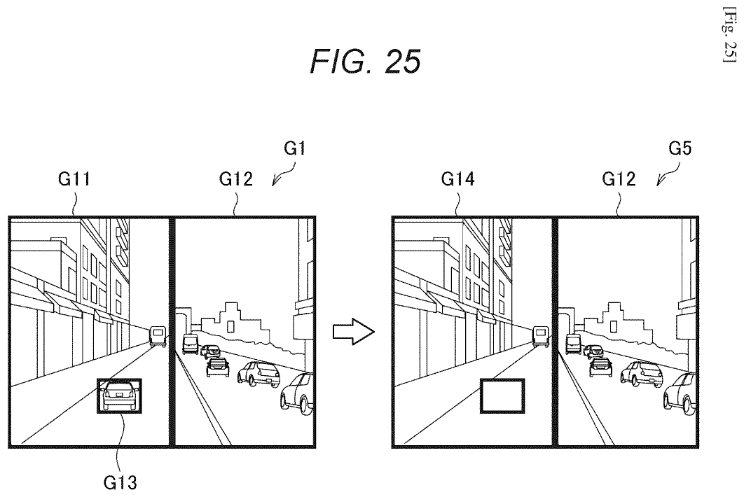

FIG. 25 is a diagram illustrating an example of the overlap region and the non-overlap region according to the third modification. Referring to FIG. 25, a learning DB image G1 is shown, and an overlap region G11 and a non-overlap region G12 included in a learning DB image G1 are shown.

In the overlap region G11, a car is shown as an example of the predetermined object. The object detection unit 270 detects a car as an example of the predetermined object from the overlap region G11. The object detection unit 270 detects a rectangular region including the region where the car is detected, as an object region G13. The region determination unit 250 determines a non-object region G14 obtained by excluding the object region G13 from the overlap region G11.

The region determination unit 250 outputs a determination result indicating which region in the learning DB image G1 is the non-object region G14, to the region division unit 236. Note that FIG. 25 shows a learning DB image G5 in which the non-object region G14 and the non-overlap region G12 are combined.

The region division unit 236 divides the learning DB image G1 into the object region G13, the non-object region G14, and the non-overlap region G12, on the basis of the determination result output from the region determination unit 250. The region division unit 236 then outputs the non-object region G14 to the summation processing unit 237, and outputs the non-overlap region G12 to the summation processing unit 238. As a result, the non-object region G14 from which the object region G13 that might adversely affect the learning is excluded is used in the learning of the feature amount extraction unit 230. Thus, the learning effectively proceeds.

The above is the description of various modifications of the information processing system 1 according to the embodiment of the present disclosure.

### 3. Example Hardware Configuration

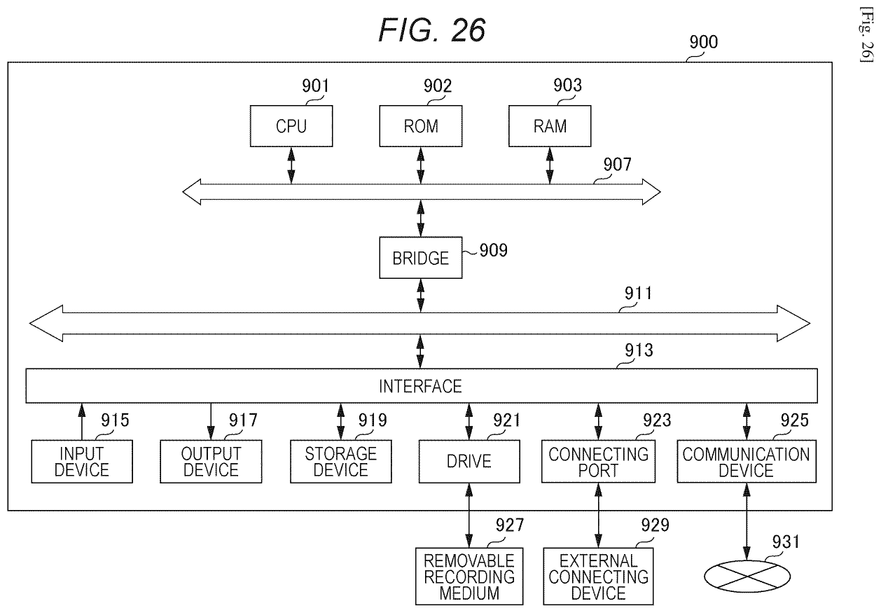

Referring now to FIG. 26, an example hardware configuration of an information processing device 900 as an example of the inference device 30 according to the embodiment of the present disclosure is described. FIG. 26 is a block diagram illustrating an example hardware configuration of the information processing device 900. Note that the inference device 30 does not necessarily have all of the hardware configurations illustrated in FIG. 26, and part of the hardware configuration illustrated in FIG. 26 does not need to exist in the inference device 30. Furthermore, the hardware configuration of the learning device 20 may be formed in a manner similar to the hardware configuration of the inference device 30.

As illustrated in FIG. 26, the information processing device 900 includes a central processing unit (CPU) 901, a read only memory (ROM) 902, and a random access memory (RAM) 903. The information processing device 900 may also include a host bus 907, a bridge 909, an external bus 911, an interface 913, an input device 915, an output device 917, a storage device 919, a drive 921, a connecting port 923, and a communication device 925. The information processing device 900 may have a processing circuit called a digital signal processor (DSP) or an application specific integrated circuit (ASIC) in place of or in combination with the CPU 901.

The CPU 901 serves as an arithmetic processing device and a control device, and controls all or some of operations in the information processing device 900 in accordance with various programs recorded in the ROM 902, the RAM 903, the storage device 919, or a removable recording medium 927. The ROM 902 stores programs, calculation parameters, and the like to be used by the CPU 901. The RAM 903 temporarily stores a program to be used in execution by the CPU 901, parameters that change as appropriate during the execution, and the like. The CPU 901, the ROM 902, and the RAM 903 are mutually connected by the host bus 907 that is formed with an internal bus such as a CPU bus. Moreover, the host bus 907 is connected to the external bus 911 such as a peripheral component interconnect/interface (PCI) bus via the bridge 909.

The input device 915 is a device that is operated by the user, such as buttons, for example. The input device 915 may include a mouse, a keyboard, a touch panel, switches, levers, and the like. Furthermore, the input device 915 may also include a microphone that detects voice of the user. The input device 915 may be a remote control device utilizing infrared light or some other radio waves, or may be an external connecting device 929 such as a mobile phone compatible with operations of the information processing device 900, for example. The input device 915 includes an input control circuit that generates an input signal on the basis of information the user has input, and outputs the input signal to the CPU 901. By operating the input device 915, the user inputs various kinds of data or gives an instruction to perform a processing operation, to the information processing device 900. Furthermore, the imaging device 933 as described later can function as an input device by capturing an image of movement of a hand of the user, a finger of the user, or the like. At this point of time, a pointing position may be determined in accordance with the movement of the hand and the orientation of the finger.

The output device 917 is formed with a device that can visually or audibly notify the user of acquired information. The output device 917 may be a display device such as a liquid crystal display (LCD) or an organic electro-luminescence (EL) display, a sound output device such as a speaker or headphones, or the like, for example. Furthermore, the output device 917 may include a plasma display panel (PDP), a projector, a hologram, a printer device, or the like. The output device 917 outputs a result obtained by processing performed by the information processing device 900 as a video such as text or an image, or outputs the result as audio such as voice or sound. Furthermore, the output device 917 may include a light or the like to brighten the surroundings.

The storage device 919 is a data storage device designed as an example of a storage unit of the information processing device 900. The storage device 919 is formed with a magnetic storage device such as a hard disk drive (HDD), a semiconductor storage device, an optical storage device, a magneto-optical storage device, or the like, for example. The storage device 919 stores programs and various kinds of data to be executed by the CPU 901, and various kinds of data acquired from the outside, and the like.

The drive 921 is a reader/writer for the removable recording medium 927, such as a magnetic disk, an optical disk, a magneto-optical disk, or a semiconductor memory, and is built in or externally attached to the information processing device 900. The drive 921 reads information recorded in the attached removable recording medium 927, and outputs the information to the RAM 903. Furthermore, the drive 921 writes records into the attached removable recording medium 927.

The connecting port 923 is a port for connecting a device directly to the information processing device 900. The connecting port 923 may be a universal serial bus (USB) port, an IEEE1394 port, a small computer system interface (SCSI) port, or the like, for example. Furthermore, the connecting port 923 may be an RS-232C port, an optical audio terminal, a high-definition multimedia interface (HDMI (registered trademark)) port, or the like. As the external connecting device 929 is connected to the connecting port 923, various kinds of data can be exchanged between the information processing device 900 and the external connecting device 929.

The communication device 925 is a communication interface that is formed with a communication device or the like for connecting to a network 931, for example. The communication device 925 may be a communication card for a wired or wireless local area network (LAN), Bluetooth (registered trademark), or wireless USB (WUSB), or the like, for example. Furthermore, the communication device 925 may be a router for optical communication, a router for asymmetric digital subscriber line (ADSL), a modem for various kinds of communication, or the like. The communication device 925 transmits and receives signals and the like to and from the Internet and other communication devices, for example, using a predetermined protocol such as TCP/IP. Furthermore, the network 931 connected to the communication device 925 is a network connected in a wired or wireless manner, and is the Internet, a home LAN, infrared communication, radio wave communication, satellite communication, or the like, for example.

### 4. Conclusion

According to the embodiment of the present disclosure, it is possible to extract an image feature amount from an image with higher accuracy, using a model obtained by learning. Also, image retrieval performance based on image feature amounts extracted by the model is expected to improve. Further, with the improvement in the image retrieval performance, the accuracy of the device position/posture information about the imaging device at the time of capture of an image is expected to increase. Furthermore, the accuracy of superimposed display of an AR object is expected to increase with the increase in the accuracy of the device position/posture information, and the accuracy of superimposed display of an image retrieval failure is expected to increase with the improvement in the image retrieval performance.

Also, according to the embodiment of the present technology, information (which is a true value label) indicating which region in a learning DB image is an overlap region is automatically attached. Thus, according to the embodiment of the present disclosure, the costs for manually attaching true value labels are lowered.

A preferred embodiment of the present disclosure has been described so far in detail with reference to the accompanying drawings, but the technical scope of the present disclosure is not limited to such an example. It is apparent that a person having ordinary knowledge in the technical field of the present disclosure can devise various changes or modifications within the scope of the technical idea disclosed in the claims, and it will naturally be understood that they also belong to the technical scope of the present disclosure.

Furthermore, the effects disclosed in the present specification are merely explanatory or exemplary, and are not restrictive. That is, the technology according to the present disclosure can provide other effects that are apparent to those skilled in the art from the description of the present specification, in addition to or instead of the abovementioned effects.

It should be understood by those skilled in the art that various modifications, combinations, sub-combinations and alterations may occur depending on design requirements and other factors insofar as they are within the scope of the appended claims or the equivalents thereof.

Note that the following configurations also belong to the technical scope of the present disclosure.
(1) An information processing apparatus including:
circuitry configured to:
receive a first image,
receive a model from a learning device, and
output a first position and a first posture based on a first image feature amount extracted from the first image and the model,
wherein the model is obtained by:
determining at least one overlap point between a second image and a third image;
dividing the second image into an overlap region including the at least one overlap point and a non-overlap region in response to determining the at least one overlap point; and
performing training based on a second image feature amount corresponding to the overlap region and a third image feature amount corresponding to the non-overlap region.
(2) The information processing apparatus according to (1), in which the received first image is captured by a terminal device.
(3) The information processing apparatus according to (1) or (2), in which the model is a three-dimensional model.
(4) The information processing apparatus according to any of (1) to (3), in which the first position and the first posture are determined based on the first image feature amount and at least one fourth image feature amount extracted from at least one high-order inference database image.
(5) The information processing apparatus according to any of (1) to (4), in which the first position and the first posture are further determined based on a vector indicated by the first image feature amount with respect to a portion of the model trained based on the at least one high-order inference database image.
(6) The information processing apparatus according to any of (1) to (5), in which the circuitry receives the model from the learning device based on a difference between a vector indicated by the first image feature amount and a vector indicated by the second image feature amount.
(7) The information processing apparatus according to any of (1) to (6), in which the circuitry receives the model from the learning device based on a ranking of a plurality of database images according to a difference between the first image feature amount and a respective database image feature amount of each respective database image of the plurality of database images.
(8) The information processing apparatus according to any of (1) to (7), in which the circuitry outputs the first position and the first posture based on a difference between a vector indicated by the first image feature amount and a vector indicated by at least one fourth image feature amount extracted from at least one high-order inference database image.
(9) The information processing apparatus according to any of (1) to (8), in which the circuitry outputs the first position and the first posture based on a ranking of a plurality of database images according to a difference between the first image feature amount and a respective database image feature amount of each respective database image of the plurality of database images.
(10) The information processing apparatus according to any of (1) to (9), in which the difference between the first image feature amount and the respective image feature amount of each respective database image indicates whether pixels of the first image correspond to pixels of each respective database image.
(11) The information processing apparatus according to any of (1) to (10), in which the circuitry is further configured to determine correspondence between pixels of the first image and pixels of each respective database image based on depths of the pixels of the first image and depths of the pixels of each respective database image.
(12) The information processing apparatus according to any of (1) to (11), in which the circuitry is further configured to estimate the depths of the pixels of the first image.
(13) The information processing apparatus according to any of (1) to (12), in which the training based on the second image feature amount corresponding to the overlap region and the third image feature amount corresponding to the non-overlap region includes training performed using a convolutional neural network.
(14) The information processing apparatus according to any of (1) to (13), in which the at least one overlap point between the second image and the third image is determined according to a density of overlap between a set of pixels of the second image and a set of pixels of the third image.
(15) The information processing apparatus according to any of (1) to (14), in which the first image feature amount is extracted from the first image based on a sum of feature amounts of pixels of the first image.
(16) The information processing apparatus according to any of (1) to (15), in which the circuitry outputs the first position and the first posture based on the sum of the feature amounts of the pixels of the first image in relation to a sum of feature amounts of pixels of the model.
(17) An information processing method including:
receiving a first image;
receiving a model from a learning device; and
outputting a first position and a first posture based on a first image feature amount extracted from the first image and the model,
wherein the model is obtained by:
determining at least one overlap point between a second image and a third image;
dividing the second image into an overlap region including the at least one overlap point and a non-overlap region in response to determining the at least one overlap point; and
performing training based on a second image feature amount corresponding to the overlap region and a third image feature amount corresponding to the non-overlap region.
(18) A non-transitory computer-readable medium having embodied thereon a program, which when executed by a computer causes the computer to function as execute an information processing method, the method comprising:
receiving a first image;
receiving a model from a learning device; and
outputting a first position and a first posture based on a first image feature amount extracted from the first image and the model,
wherein the model is obtained by:
determining at least one overlap point between a second image and a third image;
dividing the second image into an overlap region including the at least one overlap point and a non-overlap region in response to determining the at least one overlap point; and
performing training based on a second image feature amount corresponding to the overlap region and a third image feature amount.
(B1)

An information processing method implemented by a processor,
the method including:
determining whether or not an overlap position is present between a first image and a second image;
performing learning when it is determined that the overlap position is present, the learning being based on
an overlap region feature amount corresponding to an overlap region corresponding to the overlap position in a first image feature amount extracted from the first image by an extraction unit, and
a non-overlap region feature amount corresponding to a non-overlap region that is a region other than the overlap region in the first image in the first image feature amount; and
causing a model to extract a third image feature amount from a third image, the model being obtained by updating the extraction unit by the learning.
(B2)

The information processing method according to (1), in which
the learning is performed on the basis of the overlap region feature amount, the non-overlap region feature amount, and a second image feature amount extracted from the second image by the extraction unit.
(B3)

The information processing method according to (2), in which
the learning includes updating the extraction unit so that the overlap region feature amount and the second image feature amount approach each other, and the non-overlap region feature amount and the second image feature amount move away from each other.
(B4)

The information processing method according to (1), in which
the presence of the overlap position is determined on the basis of three-dimensional information related to the first image and the second image.
(B5)

The information processing method according to (4), in which
the three-dimensional information includes a three-dimensional feature point group calculated on the basis of a corresponding point pair between the first image and the second image.
(B6)

The information processing method according to (4), in which
the three-dimensional information includes information based on first position/posture information about a first imaging device at a time of capture of the first image and second position/posture information about a second imaging device at a time of capture of the second image.
(B7)

The information processing method according to (6), in which
the first position/posture information and the second position/posture information are estimated on the basis of the first image and the second image.
(B8)

The information processing method according to (6), in which
the first position/posture information and the second position/posture information are estimated by a self-localization device.
(B9)

The information processing method according to (6), in which
the first position/posture information is position/posture information about the first imaging device at the time of capture of the first image in a virtual space in which a three-dimensional model generated by computer graphics is disposed, and
the second position/posture information is position/posture information about the second imaging device at the time of capture of the second image in the virtual space.
(B10)

The information processing method according to (6), in which
the information based on the first position/posture information and the second position/posture information includes coordinates of a first three-dimensional point in a real space appearing in the first image, and coordinates of a second three-dimensional point in the real space appearing in the second image.
(B11)

The information processing method according to (10), in which
the three-dimensional information includes a normal direction with respect to an object surface at the first three-dimensional point, and a normal direction with respect to the object surface at the second three-dimensional point.
(B12)

The information processing method according to (10), in which
the coordinates of the first three-dimensional point and the coordinates of the second three-dimensional point are calculated on the basis of depth based on a predetermined origin.
(B13)

The information processing method according to (12), in which
the depth is calculated on the basis of the first image, the first position/posture information, the second image, and the second position/posture information.
(B14)

The information processing method according to (12), in which
the depth is measured by a distance measuring device.
(B15)

The information processing method according to (10), in which
the first image is an image based on a first viewpoint in a virtual space in which a three-dimensional model generated by computer graphics is disposed,
the second image is an image based on a second viewpoint in the virtual space, and
the coordinates of the first three-dimensional point and the coordinates of the second three-dimensional point are obtained from the three-dimensional model.
(B16)

The information processing method according to (1), in which
the learning is performed on the basis of a feature amount corresponding to a non-object region obtained by excluding, from the overlap region, an object region including an region in which a predetermined object is detected, and the non-overlap region feature amount.
(B17)

The information processing method according to any one of (1) to (16), further including
estimating third position/posture information about a third imaging device at a time of capture of the third image, on the basis of the third image feature amount, the processor performing the estimating.
(B18)

The information processing method according to (17), in which
the processor specifies a predetermined number of image feature amounts from image feature amounts of the respective images in a plurality of images in ascending order of difference from the third image feature amount, and estimates the third position/posture information on the basis of a fourth image corresponding to each image feature amount in the predetermined number of image feature amounts and the third image.
(B19)

An information processing device including
a model that is obtained by updating an extraction unit by learning,
in which
a check is made to determine whether or not an overlap position is present between a first image and a second image,
when it is determined that the overlap position is present,
the learning is performed on the basis of
an overlap region feature amount corresponding to an overlap region corresponding to the overlap position in a first image feature amount extracted from the first image by an extraction unit, and
a non-overlap region feature amount corresponding to a non-overlap region that is a region other than the overlap region in the first image in the first image feature amount, and
the model extracts a third image feature amount from a third image.
(B20)

A program for causing a computer to:
determine whether or not an overlap position is present between a first image and a second image;
perform learning when it is determined that the overlap position is present, the learning being based on
an overlap region feature amount corresponding to an overlap region corresponding to the overlap position in a first image feature amount extracted from the first image by an extraction unit, and
a non-overlap region feature amount corresponding to a non-overlap region that is a region other than the overlap region in the first image in the first image feature amount; and
cause a model to extract a third image feature amount from a third image, the model being obtained by updating the extraction unit by the learning.

### Reference Signs List

1 Information processing system
10 Terminal device
110 Imaging device
120 Operating unit
150 Storage unit
160 Presentation unit
20 Learning device
200 Control unit
210 Three-dimensional restoration unit
212 Position/posture estimation unit
214 Depth estimation unit
216 Point cloud generation unit
217 Mesh generation unit
220 Overlap point extraction unit
230 Feature amount extraction unit
231 Learning query image feature amount extraction unit
232 Pixel feature amount extraction unit
233 Summation processing unit
234 Feature amount extraction unit
235 Pixel feature amount extraction unit
236 Region division unit
237 Summation processing unit
238 Summation processing unit
240 Learning loss calculation unit
250 Region determination unit
260 Update unit
270 Object detection unit
290 Memory
30 Inference device
300 Control unit
310 Image retrieval unit
312 Image feature amount extraction unit
314 Image feature amount matching unit
320 Feature point matching unit
322 Pixel feature amount extraction unit
324 Pixel feature amount matching unit
330 Relative position/posture estimation unit
340 Device position/posture estimation unit
390 Memory
40 Network
610 Distance measuring device
620 SLAM device
710 CG
811 Imaging device
812 Imaging device
814 Imaging device

1. An information processing apparatus comprising:
circuitry configured to:
receive a first image,
receive a model from a learning device, and
output a first position and a first posture based on a first image feature amount extracted from the first image and the model,
wherein the model is obtained by:
determining at least one overlap point between a second image and a third image;
dividing the second image into an overlap region including the at least one overlap point and a non-overlap region in response to determining the at least one overlap point; and
performing training based on a second image feature amount corresponding to the overlap region and a third image feature amount corresponding to the non-overlap region.

2. The information processing apparatus according to claim 1,
wherein the received first image is captured by a terminal device.

3. The information processing apparatus according to claim 1,
wherein the model is a three-dimensional model.

4. The information processing apparatus according to claim 1,
wherein the first position and the first posture are determined based on the first image feature amount and at least one fourth image feature amount extracted from at least one high-order inference database image.

5. The information processing apparatus according to claim 4,
wherein the first position and the first posture are further determined based on a vector indicated by the first image feature amount with respect to a portion of the model trained based on the at least one high-order inference database image.

6. The information processing apparatus according to claim 1,
wherein the circuitry receives the model from the learning device based on a difference between a vector indicated by the first image feature amount and a vector indicated by the second image feature amount.

7. The information processing apparatus according to claim 1,
wherein the circuitry receives the model from the learning device based on a ranking of a plurality of database images according to a difference between the first image feature amount and a respective database image feature amount of each respective database image of the plurality of database images.

8. The information processing apparatus according to claim 1,
wherein the circuitry outputs the first position and the first posture based on a difference between a vector indicated by the first image feature amount and a vector indicated by at least one fourth image feature amount extracted from at least one high-order inference database image.

9. The information processing apparatus according to claim 1,
wherein the circuitry outputs the first position and the first posture based on a ranking of a plurality of database images according to a difference between the first image feature amount and a respective database image feature amount of each respective database image of the plurality of database images.

10. The information processing apparatus according to claim 9,
wherein the difference between the first image feature amount and the respective image feature amount of each respective database image indicates whether pixels of the first image correspond to pixels of each respective database image.

11. The information processing apparatus according to claim 10,
wherein the circuitry is further configured to determine correspondence between pixels of the first image and pixels of each respective database image based on depths of the pixels of the first image and depths of the pixels of each respective database image.

12. The information processing apparatus according to claim 11,
wherein the circuitry is further configured to estimate the depths of the pixels of the first image.

13. The information processing apparatus according to claim 1,
wherein the training based on the second image feature amount corresponding to the overlap region and the third image feature amount corresponding to the non-overlap region includes training performed using a convolutional neural network.

14. The information processing apparatus according to claim 1,
wherein the at least one overlap point between the second image and the third image is determined according to a density of overlap between a set of pixels of the second image and a set of pixels of the third image.

15. The information processing apparatus according to claim 1,
wherein the first image feature amount is extracted from the first image based on a sum of feature amounts of pixels of the first image.

16. The information processing apparatus according to claim 15,
wherein the circuitry outputs the first position and the first posture based on the sum of the feature amounts of the pixels of the first image in relation to a sum of feature amounts of pixels of the model.

17. An information processing method comprising:
receiving a first image;
receiving a model from a learning device; and
outputting a first position and a first posture based on a first image feature amount extracted from the first image and the model,
wherein the model is obtained by:
determining at least one overlap point between a second image and a third image;
dividing the second image into an overlap region including the at least one overlap point and a non-overlap region in response to determining the at least one overlap point; and
performing training based on a second image feature amount corresponding to the overlap region and a third image feature amount corresponding to the non-overlap region.

18. A non-transitory computer-readable medium having embodied thereon a program, which when executed by a computer causes the computer to function as execute an information processing method, the method comprising:
receiving a first image;
receiving a model from a learning device; and
outputting a first position and a first posture based on a first image feature amount extracted from the first image and the model,
wherein the model is obtained by:
determining at least one overlap point between a second image and a third image;
dividing the second image into an overlap region including the at least one overlap point and a non-overlap region in response to determining the at least one overlap point; and
performing training based on a second image feature amount corresponding to the overlap region and a third image feature amount corresponding to the non-overlap region.
